(19) United States
(12) Patent Application Publication
(10) Pub. No.: US 2026/0106752 A1
(43) Pub. Date: Apr. 16, 2026

(54) METHODS, DEVICES AND SYSTEMS FOR SECURELY TRANSMITTING AND RECEIVING DATA AND FOR REPLENISHING PRE-SHARED KEYS

(71) Applicant: PHOTONIC INC., Coquitlam (CA)

(72) Inventors: Evan MEYER-SCOTT, Edmonton (CA); Stephanie SIMMONS, Burnaby (CA)

(21) Appl. No.: 19/105,190

(22) PCT Filed: Aug. 18, 2023
(86) PCT No.: PCT/CA2023/051097

§ 371 Date: Feb. 20, 2025

Related U.S. Application Data
(60) Provisional application No. 63/402,889, filed on Aug. 31, 2022.

(51) Int. Cl. H04L 9/08; H04L 9/40

(52) U.S. Cl. CPC H04L 9/0894; H04L 9/0852; H04L 63/0428

(57) ABSTRACT

In a method for supporting secure data transmission between a first device and a second device, the first device and a trusted authority, TA, possess a first-device pre-shared key, PSK, and the second device and the TA possess a second-device PSK. The TA generates parity information between the first-device PSK and the second-device PSK. The TA communicates the parity information to at least one of the first device and the second device.

### CROSS-REFERENCE TO RELATED APPLICATIONS

This application claims priority from U.S. application No. 63/402,889 filed 31 Aug. 2022 and entitled METHODS, DEVICES AND SYSTEMS FOR SECURELY TRANSMITTING AND RECEIVING DATA AND FOR REPLENISHING PRE-SHARED KEYS which is hereby incorporated herein by reference for all purposes. For purposes of the United States of America, this application claims the benefit under 35 U.S.C. § 119 of U.S. application No. 63/402,889 filed 31 Aug. 2022 and entitled METHODS, DEVICES AND SYSTEMS FOR SECURELY TRANSMITTING AND RECEIVING DATA AND FOR REPLENISHING PRE-SHARED KEYS which is hereby incorporated herein by reference for all purposes.

### FIELD

This invention generally relates to communication networks and devices and more particularly to methods, devices and systems for securely transmitting and receiving data, to methods and devices for supporting secure data transmission, as well as to methods and devices for replenishing pre-shared keys (PSKs).

### BACKGROUND

Secure communication requires encryption of the data to be transmitted. Encryption systems can be classified into symmetric encryption systems and asymmetric encryption systems.

Asymmetric encryption uses two different keys for encryption and decryption. A public key, which is shared among users, is used to encrypt the data. A private key, which is not shared, is used to decrypt the data. Well-regarded asymmetric encryption algorithms comprise the Rivest-Shamir-Adleman (RSA) cryptosystem or elliptic-curve cryptography and are based on an assumed difficulty of certain mathematical problems. The most important problems are the integer factorization problem, the discrete logarithm problem and the elliptic-curve discrete logarithm problem. These problems, however, are known to be broken by quantum computers running Shor's algorithm. In the future, other or additional approaches to secure sensitive data are therefore required, for example for sensitive communications, medical and commercial records, and banking transactions. These approaches may comprise symmetric encryption algorithms.

In methods with symmetric encryption, there is a single key which is known to both communicating parties. This single key must be protected from unauthorized access by third parties. A primary challenge of symmetric encryption is therefore ensuring that the key is distributed in a secure way, which is known as the “key distribution problem”.

Quantum communication can be used to distribute keys. In quantum communication, communicating parties exchange information encoded in quantum states. From EP 2 622 784 B1, a secure multi-party communication with quantum key distribution (QKD) managed by a trusted authority (TA) is known. U.S. Pat. No. 9,002,009 B2 relates to QKD using a card, a base station and a trusted authority. From CN 109995513 B, a low-delay quantum key mobile service method is known. U.S. Pat. No. 8,340,298 B2 relates to key management and user authentication for quantum cryptography networks. Further, US 2017/0244687 A1 describes techniques for confidential delivery of random data over a network.

In QKD protocols, information reconciliation and privacy amplification can be used to systematically increase the correlation between the keys, while mutual information of a potential eavesdropper is reduced. Herein, information reconciliation corresponds to error correction conducted over a public channel. Privacy amplification increases the correlation. An example of a privacy amplification method is described in Bennett et al., “Generalized privacy amplification,” in IEEE Transactions on Information Theory, vol. 41, no. 6, pp. 1915-1923 November 1995. Random compression functions are used that can be publicly shared between the communicating parties.

### SUMMARY OF THE INVENTION

The present disclosure has several aspects, including methods, devices and systems for securely transmitting and receiving data, including methods and devices for supporting secure data transmission, and further including methods and devices for replenishing pre-shared keys (PSKs).

A first aspect of the disclosure provides a method for supporting secure transmission between a first device and a second device. The first device and a trusted authority (TA) possess (share) a first-device PSK. The second device and the TA possess a second-device PSK. The TA generates parity information between the first-device PSK and the second-device PSK. The TA communicates the parity information to at least one of the first device and the second device.

In this specification, “parity information” between the first-device PSK and the second-device PSK may relate to information that allows the first device to deduce the second-device PSK and/or information that allows the second-device to deduce the first-device PSK.

In this specification, the term “TA” (trusted authority) may refer to a third party trusted to distribute keys between devices. The third party can be a manufacturer of the first device and/or the second device, a government institution, a trusted non-governmental organization (NGO) or the like. Depending on the context, the term “TA” can more particularly refer to a computing system of the third party.

In this specification, a “pre-shared” key (PSK) may relate to a key that is (exclusively) shared by the TA and the respective device, i.e., the key is known solely to the TA and the respective device.

The method allows the first device and the second device to generate an encryption/decryption key which can be used for secure transmittal of data.

In an embodiment of the method according to the first aspect, the first device receives the parity information. The first device deduces the second-device PSK using the parity information, uses the deduced second-device PSK to encrypt data, and sends the encrypted data to the second device. The second device decrypts the data, using the second-device PSK.

In an embodiment of the method according to the first aspect, the second device receives the parity information and deduces the first-device PSK using the parity information. The first device uses the first-device PSK to encrypt data and sends the encrypted data to the second-device PSK. The second device decrypts the data, using the deduced first-device PSK.

In an embodiment of the method according to the first aspect, the TA communicates the parity information to the first device and/or second device over a public channel. The TA may also communicate the parity information over a private channel.

In an embodiment of the method according to the first aspect, the TA communicates the parity information to at least one of the first device and the second device using quantum networking, e.g., by a quantum communication scheme such as quantum key distribution, QKD, method.

In an embodiment of the method according to the first aspect, the TA generates the parity information by applying bitwise XOR to the first-device PSK and the second-device PSK.

In an embodiment of the method according to the first aspect, the TA generates the parity information by generating information for the first device, and further advising the first device which bits of the first-device PSK the first device needs to flip in order to obtain the second-device PSK.

In an embodiment of the method according to the first aspect, the TA receives a request message from the first device, requesting the TA to support secure transmittal of data from the first device to the second device. The TA generates and communicates the parity information in response to the request.

In an embodiment of the method according to the first aspect, the TA performs an authentication process with the first device to determine that the first device is authorized to communicate with the second device.

In an embodiment of the method according to the first aspect, the TA receives information from the first device, indicative of a length of data to be transmitted from the first device to the second device. The TA generates the parity information having a length which is based on the length of the data to be transmitted from the first device to the second device. For example, the TA may generate the parity information by applying XOR to a portion of the first-device PSK and a portion of the second-device PSK, each having a length corresponding to the length of the data to be transmitted.

In an embodiment of the method according to the first aspect, the TA generates parity information of a portion of the first-device PSK and a portion of the second-device PSK for which no parity information has been previously generated.

In an embodiment of the method according to the first aspect, the TA sends a new first-device PSK to the first device for replenishing the first-device PSK shared by the TA and the first device.

In an embodiment of the method according to the first aspect, the TA sends the new first-device PSK to the first device over a quantum network, e.g., via a quantum communication scheme, such as quantum key distribution, QKD, method.

In an embodiment of the method according to the first aspect, the first device and each TA of a plurality of TAs possess a respective first-device PSK. The second device and each TA of the plurality of TAs, possess a respective second-device PSK. The method is performed by each TA of the plurality of TAs. Each TA of the plurality of TAs has no information about the respective PSK shared by the first device (or second device) and another TA.

In an embodiment of the method according to the first aspect, the TA can be a distributed entity. Herein, a distributed entity means that the TA encompasses more than one physical location, e.g., in different rooms, buildings, cities or countries. A distributed TA can facilitate convenient and more secure communication with distant first and second devices. For example, a first TA component can be located closer to the first device, e.g. can be located in the same building, room, city or country. A second TA component can be located closer to the second device, e.g. can be located in the same building, room, city or country. Then, only short links are required, namely a first link from the first TA component to the first device and a second link from the second TA component to the second device. Such short links are more easily secured to replenish keys to the first and second device, respectively. To allow the first device and the second device to communicate, the TA can bring the distant replenished PSKs together. This could be accomplished by secured internal networks or couriers, for example quantum networks which distribute internal PSKs for sharing device PSKs within the distributed TA.

A second aspect of the disclosure provides a method for securely transmitting data from a first device to a second device. The first device shares with each TA of a plurality of TAs a respective first-device PSK of a plurality of first-device PSKs. The first device receives from each TA of the plurality of TAs a respective encrypted second-device PSK of a plurality of second-device PSKs. The second-device PSK is shared between the TA and the second device. The first device decrypts each encrypted second-device PSK, using the first-device PSK shared with the TA associated with the second-device PSK. The first device generates a key, using the plurality of second-device PSKs decrypted by the first device. The first device encrypts data using the generated key. The first device sends the encrypted data to the second device.

The method therefore involves multiple TAs. If there is only a single TA, the TA is able to decrypt and read all messages for which it holds keys. Therefore, users must have absolute confidence in the TA and if the TA is corrupted, the security of the entire transmission method is at risk. Relying on the integrity of a single TA may be undesired when exchanging classified and/or sensitive information between communicating parties. Using multiple TAs according to the second aspect of the disclosure provides a robust solution to the key distribution problem without having to trust a single TA. Each TA of the plurality of TAs only has access to the respective second-device PSK it shares with the second device.

The first-device PSKs are preferably only known to the first device and the corresponding TA. Likewise, the second-device PSKs are preferably only known to the second device and the corresponding TA. In other words, the TA uses different PSK for each first device and each second device. Moreover, different TAs use different PSKs.

In an embodiment of the method according to the second aspect, the first device uses all of the second-device PSKs of the plurality of second-device PSKs for generating the key. Therefore, the first device encrypts the data using the generated key which depends on all of the second-device PSKs. Each single TA is therefore not able to generate the key by itself and does not have access to the encrypted data.

In an embodiment of the method according to the second aspect, the first device uses only a proper subset of the set of the plurality of second-device PSKs for generating the key. The subset comprises at least two second-device PSKs.

In an embodiment of the method according to the second aspect, the steps of decrypting each encrypted second-device PSK and of generating the key are performed in a single method step.

For example, the first device may use the following formula for generating the key K_{B12}:

$${K}_{B 12} = ( {K}_{AB 1} ⊕ {K}_{A 1} ) ⊕ ( {K}_{AB 2} ⊕ {K}_{A 2} ) . \qquad ( 1 )$$

Herein, ⊕ denotes the bitwise XOR operation and K_{A1} and K_{A2} denote the first-device PSKs shared between the first device and a first TA and a second TA, respectively. Further, K_{AB1} and K_{AB2} denote the encrypted second-device PSK shared between the second device and the first TA or the second TA, respectively. Each TA has encrypted the respective second-device PSK by applying a bitwise XOR of the first-device PSKs and the second-device PSKs, i.e., using the following formulas:

$${K}_{AB 1} = {K}_{B 1} ⊕ {K}_{A 1} , \qquad ( 2 )$$

$${K}_{AB 2} = {K}_{B 2} ⊕ {K}_{A 2} . \qquad ( 3 )$$

Herein, K_{B1} and K_{B2} denote the second-device PSKs shared between the second device and the first TA and the second TA, respectively.

The key K_{B12} is therefore identical to:

$${K}_{B 12} = ( {K}_{B 1} ⊕ {K}_{A 1} ⊕ {K}_{A 1} ) ⊕ ( {K}_{B 2} ⊕ {K}_{A 2} ⊕ {K}_{A 2} ) = {K}_{B 1} ⊕ {K}_{B 2} \qquad ( 4 )$$

In the above formula (1), the XOR operation K_{AB1}⊕K_{A1} corresponds to the step of decrypting, by the first device, the second-device PSK K_{B1} shared between the second device and the first TA. Further, the XOR operation K_{AB2}⊕K_{A2} corresponds to the step of decrypting, by the first device, the second-device PSK K_{B2} shared between the second device and the second TA.

The second device can generate the key K_{B12} as well, using formula (4), i.e., by computing K_{B12}=K_{B1}⊕K_{B2}. No knowledge of the first-device PSKs is necessary.

Therefore, the key K_{B12} can be used for symmetric encryption methods.

The above formulas can be extended to more than two TAs by applying the XOR operation to further terms of the form K_{ABi}⊕K_{Ai}, where the index i denotes the respective TA. Herein, K_{ABi} denotes the encrypted second-device PSK shared between the second device and the i-th TA and K_{Ai} denotes the first-device PSK shared between the first device and the i-th TA.

In an embodiment of the method according to the second aspect, the plurality of TAs comprises at least three TAs and there is a corresponding unique first-device PSK for each TA. By providing a larger number of TAs, the security of the method increases.

In an embodiment of the method according to the second aspect, at least some of the first-device PSKs and/or second-device PSKs are single-use PSKs. In an embodiment, all of the first-device PSKs and all of the second-device PSKs are single-use PSKs. By using the PSKs only once, the security of the method further increases. An eavesdropper intercepting a single key cannot decrypt subsequently encrypted data.

In an embodiment of the method according to the second aspect, generating the key comprises the first device computing a function of the second-device PSKs of the plurality of second-device PSKs. The generated key differs from any of the second-device PSKs of the plurality of second-device PSKs. For example, the first device may combine all of the second-device PSKs by a bitwise XOR operation according to formula (1) above. Other ways to combine the PSKs can comprise key wrap protocols or key encapsulation mechanisms.

In an embodiment of the method according to the second aspect, the first device receives at least one of the first-device PSKs from the corresponding TA of the plurality of TAs over a quantum network, e.g., using a QKD method. The first device stores the at least one received first-device PSK in a memory of the first device. Point-to-point QKD methods can solve the key distribution method by using cryptographic protocols based on quantum states. If an eavesdropper tries to intercept the key, the system is disturbed which can in turn be detected.

In an embodiment of the method according to the second aspect, the first device receives at least one of the first-device PSKs from the corresponding TA of the plurality of TAs by physical distribution using trusted carriers.

In an embodiment of the method according to the second aspect, the first device receives at least one of the first-device PSKs from the corresponding TA of the plurality of TAs before the first device is packaged or sold. The first device stores the at least one received first-device PSK in a memory of the first device. For example, the TA may be a manufacturer of the first device and preloads first-device PSKs during manufacturing. Copies of the first-device PSKs and/or copies of the second-device PSKs may be kept secure in the manufacturer's server.

For some encryption schemes, e.g., one-time pad (OTP), the first-device PSK or the second-device PSK to be used must be at least the length of the data to be encrypted. Therefore, the length of the preloaded PSK might be chosen to be sufficiently long. For example, the PSK might be chosen to be long enough that replenishing the PSK is not necessary over the expected lifetime of the first device.

In other embodiments, the first-device PSK may be replenished. To ensure compliance with the key length of OTP, the length of the PSK may also be specified in advance. In other embodiments, an upper bound is specified and the message is padded with zeros before encryption.

In the following, reference to “the first-device PSK” or reference to “the second-device PSK” is intended to include reference to only a portion of the first-device PSK or the second-device PSK, unless the context indicates otherwise. For example, the first device may use only a portion of the first-device PSK for decrypting the second-device PSK, or the first device may generate the key, using only a portion of each second device PSK.

In some embodiments, the first device may select the size of the used portion of the first-device PSK or the second-device PSK depending on the data to be encrypted or decrypted. For example, if OTP is used, the portion of the first-device PSK or the second-device PSK, respectively, may be selected such that the length of the portion corresponds to the length of the data to be decrypted or encrypted, respectively. This process may be done asynchronously between the first device and the TA. For example, the first device may encrypt the data by just using as much of generated key as necessary for the encryption, and then inform the TA which part of the first-device PSK was used.

In an embodiment of the method according to the second aspect, encrypting the data comprises the first device using the generated key as an OTP key to encrypt the data. OTP uses identical private keys shared between pairs of users to symmetrically encrypt and decrypt information. OTP is information theoretically secure, meaning it cannot be broken by advances in computing power, provided that the key is at least as long as the length of the data to be encrypted, the key is truly random, is not reused and is securely distributed to the communicating parties. According to the method according to the second aspect, the key distribution problem is solved by using multiple TAs. Further, the generated key can be applied in symmetric encryption schemes because the key can be generated by the second device as well. Namely, only knowledge of the second-device PSKs is necessary for generating the key, not of the first-device PSKs.

The method is not restricted to OTP but is applicable to other symmetric encryption algorithms. In an embodiment of the method according to the second aspect, the generated key is used in a Data Encryption Standards (DES) algorithm, an Advanced Encryption Standard (AES) algorithm or a Twofish algorithm.

In an embodiment of the method according to the second aspect, the first device performs an authentication process with at least one TA of the plurality of TAs, allowing the TA to determine that the first device is authorized to communicate with the second device. In an embodiment, each TA performs an authentication process with the first device before the TA provides the respective second-device PSK. The authentication process may use a classical authentication protocol, e.g., password-based or public-key authentication. The TA may assign certain permissions to users such as the first device. The TA may classify the users, using different classes, each having at least partially different permissions.

In an embodiment of the method according to the second aspect, if the authentication process fails, the TA may ask the first device to register first with the TA. That is, the first device may still be unknown to the TA and needs to register first. For example, the TA may request personal data from the user of the first device for registration, such as a name, postal address, telephone number and/or email address of the user. The registration may involve a more in-depth authentication, for example, a verification of personal identification, a two-factor authentication, or a confirmation of the identity of the user by a third party.

In an embodiment of the method according to the second aspect, the first device sends a request message to each TA of the plurality of TAs, indicative of a size of the respective second-device PSK sufficient for generating the key. For example, the request message may specify a required number of blocks of the second-device PSK. The TA may provide (part of) the second-device PSK having a size greater than or equal than the size indicated in the request message. In an embodiment, the size can be equal to the size indicated in the request message, thereby keeping the size of the used second-device PSK at the required minimum.

In an embodiment of the method according to the second aspect, the first device receives a new first-device PSK from at least one TA of the plurality of TAs for replenishing the first-device PSKs shared with the TA. By having the opportunity of replenishing the first-device PSKs, the required memory of the first device can be reduced.

In an embodiment of the method according to the second aspect, the first device receives the new first-device PSK from the TA over a quantum network, e.g., using a QKD method. The replenishing of the first-device PSKs can be performed in a secure way by using a QKD method.

In an embodiment of the method according to the second aspect, the first device combines the new first-device PSK with at least a portion of a pre-existing first-device PSK, using a privacy amplification method. Thereby, the trust needed in both the new first-device PSK and the pre-existing first-device PSK is reduced. Herein, a “pre-existing” or “current” first-device PSK is a first-device PSK that already exists prior to PSK replenishment, e.g. is already stored in a memory of the first device. An example of a privacy amplification method which may be used is described in Bennett et al., “Generalized privacy amplification,” cited above. Herein, random compression functions are used that can be publicly shared between the communicating parties.

In an embodiment of the method according to the second aspect, the first device provides information to the TA, wherein the information comprises characteristics of the used privacy amplification method. In the example above, the first device may provide information characterizing the used compression function to the TA.

In an embodiment of the method according to the second aspect, the first device provides information to the TA, wherein the information comprises a characterization of the used portion of the current first-device PSK. For example, the first device may provide a start index and a length of the used portion of the current first-device PSK.

In an embodiment of the method according to the second aspect, receiving the new first-device PSK comprises receiving the new first-device PSK at a trusted physical location. The trusted physical location can be a bank, an automated telling machine, a government building, or a store associated with the TA. By obtaining the new first-device PSK at the trusted physical location, trust of the user in the PSK replenishment process increases. The probability that a third party manipulates the new first-device PSK decreases if the new first-device PSK is provided at the trusted physical location.

In an embodiment of the method according to the second aspect, the first device or a user of the first device must go through an authentication procedure at the trusted physical location before the first-device PSK is provided to the first device.

In an embodiment of the method according to the second aspect, receiving the new first-device PSK comprises the first device establishing a data connection with a station located at the trusted physical location. The first device receives the new first-device PSK via the station. In an embodiment, the station is a device docking station and the first device physically connects (e.g., by connecting the first device to a cable or a plug-in interface) with the station to establish data communication with the station. The station may itself store the new first-device PSK in a memory of the station before the new first-device PSK is provided to the first device. In another embodiment, the new first-device PSK is passed through the station and provided to the first device without having a local copy in a memory of the station.

In an embodiment of the method according to the second aspect, the first device connects to the station via a near field communication (NFC) interface, Bluetooth interface, or the like.

In an embodiment of the method according to the second aspect, a new TA can be added to the plurality of TAs. For example, the first device may register with the new TA. The first device informs the new TA that it wishes to communicate with the second device. The new TA checks if the second device is already registered with the new TA. If this is not case, the TA may request that the second device registers first. Next, the new TA checks if it already shares a second-device PSK with the second device. If this is not the case, the new TA provides a second-device PSK to the second device. The new TA encrypts the second-device PSK using the first-device PSK and provides the encrypted second-device PSK to the first device. The first device then decrypts the encrypted second-device PSK received from the new TA and uses it together with the other second-device PSKs to generate the key.

In an embodiment of the method according to the second aspect, the first device and the second device are each any one of a data server, a personal computer, a mobile phone, a tablet computer, a personal digital assistant, a wearable electronic device, a virtual reality device, a robot, an industrial device, or a smart vehicle.

A third aspect of the disclosure provides a method for securely transmitting data from a first device to a second device. The first device receives from each trusted authority, TA, of a plurality of TAs, a respective second-device pre-shared key, PSK, of a plurality of second-device PSKs. Each second-device PSK is shared between the respective TA and the second device. The first device generates a key, using the plurality of second-device PSKs by the first device. The first device encrypts data, using the generated key. The first device sends the encrypted data to the second device.

In contrast to the second aspect, encryption (by the TA) and decryption (by the first device) of the second-device PSK might not be necessary in the method according to the third aspect. For example, the communication channels between the first device and each TA might be considered to be secure, i.e. there can be no eavesdropper. However, the user may not have absolute confidence in one or more of the TAs. For the same reasons as above, the method then improves the security because no single TA acting by itself (without help from the other TAs) can generate the key used in encrypting the data.

A fourth aspect of the disclosure provides a method for securely receiving data from a first device by a second device. The second device shares with each TA of a plurality of TAs a respective second-device PSK of a plurality of second-device PSKs. The second device receives encrypted data from the first device. The second device decrypts the received encrypted data, using a key generated from combining the plurality of second-device PSKs.

According to the fourth aspect, the encrypted data may have been encrypted by the first device using the method according to the second or third aspect or any embodiment according to the second or third aspect described above. That is, the first device may have encrypted the data using the plurality of second-device PSKs which may have been provided to the first device via a plurality of TAs. Each TA only has access to one of the second-device PSKs. Therefore, no TA acting by itself (i.e., without colluding with other TAs) can decrypt the encrypted data. Therefore, the method is secure against corruption of one TA or a subset of the TAs (i.e., not all of the TAs).

In an embodiment of the method according to the fourth aspect, decrypting the received encrypted data comprises the second device generating a key, using each second-device PSK of the plurality of second-device PSKs. The second device uses the generated key to decrypt the received encrypted data. The second device may generate the key by combining the second device PSKs, e.g., by applying a bitwise XOR operation to the second-device keys.

The methods according to the second and fourth aspect can be considered as respective parts of a method for securely transmitting data from a first device to a second device according to another aspect of the disclosure.

A fifth aspect of the disclosure provides a method for securely transmitting data from a first device to a second device, wherein the first device shares, with a TA a first-device PSK. The first device encrypts data, using the first-device PSK. The first device sends the encrypted data to the second device. The first device sends a request message to the TA, requesting that the TA sends at least a portion of the first-device PSK to the second device, wherein prior to sending the first-device PSK to the second device, the TA is to encrypt the first-device PSK using a second-device PSK shared between the TA and the second device.

In an embodiment of the method according to the fifth aspect, the first device shares a respective first-device PSK with a plurality of TAs. The first device encrypts the data, using the first-device PSKs, and sends the encrypted data to the second device. The first device sends a respective request message to each TA, requesting that the TA sends at least a portion of the respective first-device PSK to the second device, wherein prior to sending the first-device PSK to the second device, the TA is to encrypt the first-device PSK using a respective second-device PSK shared between the TA and the second device. In this embodiment, by using a plurality of TAs, the security of the method further improves, as described above with respect to the method according to the second, third and fourth aspect.

In an embodiment of the method according to the fifth aspect, at least some of the first-device PSKs and/or second-device PSKs are single-use PSKs.

In this embodiment, the first device may provide the encrypted data to the second device over a public channel. Because only the first device and the TA has access to the first-device PSK, the encrypted data cannot be decrypted by any eavesdropper. Further, the first device may communicate with the TA over a secure channel. Likewise, the TA may communicate with the second device over a secure channel. The TA provides the first-device PSK (or a portion thereof) to the second device. The second device can then decrypt the encrypted data, using the received first-device PSK (or a portion thereof). The first device can therefore securely communicate with the second device.

In an embodiment of the method according to the fifth aspect, the first device encrypts the data using only a portion of the first-device PSK. The first device transmits information characterizing the used portion of the first-device PSK to the TA. Sending the request message to the TA comprises the first device requesting the TA to send only the used portion of the encrypted first-device PSK to the second device. The key length (i.e., the size of the portion of the first-device PSK) can be flexible in this embodiment. Moreover, only the portion of the encrypted first-device PSK that is actually used for encryption is provided to the second-device PSK. Unnecessary data transfer can be avoided in this way. Moreover, replenishing the first-device PSK may be avoided or postponed to a later time.

In an embodiment of the method according to the fifth aspect, encrypting the data comprises the first device using the generated key as an OTP key to encrypt the data.

The method is not restricted to OTP but is applicable to other symmetric encryption algorithms. In an embodiment of the method according to the fifth aspect, the generated key is used in a Data Encryption Standards (DES) algorithm, an Advanced Encryption Standard (AES) algorithm or a Twofish algorithm.

In an embodiment of the method according to the fifth aspect, the first device performs an authentication process with the TA, allowing the TA to determine that the first device is authorized to communicate with the second device. The authentication process may use a classical authentication protocol, e.g., password-based or public-key authentication.

In an embodiment of the method according to the fifth aspect, if the authentication process fails, the TA may ask the first device to register first with the TA. That is, the first device may still be unknown to the TA and needs to register first. For example, the TA may request personal data from the user of the first device for registration, such as a name, postal address, telephone number and/or email address of the user. The registration may involve a more in-depth authentication, for example, a verification of personal identification, a two-factor authentication, or a confirmation of the identity of the user by a third party.

In an embodiment of the method according to the fifth aspect, the first device receives a new first-device PSK from the TA for replenishing the first-device PSK shared with the TA.

In an embodiment of the method according to the fifth aspect, the first device receives the new first-device PSK from the TA over a quantum network, e.g., via a QKD method.

In an embodiment of the method according to the fifth aspect, the first device combines the new first-device PSK with at least a portion of the pre-existing first-device PSK, using a privacy amplification method.

In an embodiment of the method according to the fifth aspect, the first device provides information to the TA, wherein the information comprises characteristics of the used privacy amplification method.

In an embodiment of the method according to the fifth aspect, the first device provides information to the TA, wherein the information comprises a characterization of the used portion of the pre-existing first-device PSK.

In an embodiment of the method according to the fifth aspect, receiving the new first-device PSK comprises receiving the new first-device PSK at a trusted physical location. The trusted physical location can be a bank, an automated telling machine, a government building, or a store associated with the TA.

In an embodiment of the method according to the fifth aspect, the first device or a user of the first device must go through an authentication procedure at the trusted physical location before the first-device PSK is provided to the first device.

In an embodiment of the method according to the fifth aspect, receiving the new first-device PSK comprises the first device establishing a data connection with a station located at the trusted physical location. The first device receives the new first-device PSK via the station. In an embodiment, the station is a device docking station and the first device physically connects (e.g., by connecting the first device to a cable or a plug-in interface) with the station to establish data communication with the station. The station may itself store the new first-device PSK in a memory of the station before the new first-device PSK is provided to the first device. In another embodiment, the new first-device PSK is passed through the station and provided to the first device without retaining a local copy in a memory of the station.

In an embodiment of the method according to the fifth aspect, the first device connects to the station via a near field communication (NFC) interface, Bluetooth interface, or the like.

A sixth aspect of the disclosure provides a method for securely receiving data from a first device by a second device. The second device shares with a TA a second-device PSK. The second device receives encrypted data from the first device. The second device receives an encrypted first-device PSK from the TA. The first-device PSK is shared between the first device and the TA. The second device decrypts the received encrypted first-device PSK, using the second-device PSK. The second device decrypts the received encrypted data, using the decrypted first-device PSK.

According to the sixth aspect, the encrypted data may have been encrypted by the first device using the method according to the fifth aspect or any embodiment according to the fifth aspect described above.

In an embodiment of the method according to the sixth aspect, the second device receives information characterizing a portion of the second-device PSK from the TA. The second device decrypts the received encrypted first-device PSK using only the portion of the second-device PSK. In an embodiment, the first device has encrypted the data using the first-device PSK or portion thereof as an OTP key. The TA encrypts the first-device PSK or portion thereof, using a portion of the second-device PSK having the same length as the first-device PSK or portion thereof, and provides the second device with information regarding the portion of the second-device PSK that was used for the encryption. By informing the second device about the used portion of the second-device PSK, unnecessary data transfer may be avoided and replenishing the second-device PSK may be avoided or postponed to a later time.

A seventh aspect of the disclosure provides a method for supporting secure transmittal of data from a first device to a second device, wherein the first device shares with a TA a first-device PSK and wherein the second device shares a second-device PSK with the TA. The TA receives a request message from the first device, requesting the TA to send at least a portion of the first-device PSK to the second device. The TA encrypts the at least a portion of the first-device PSK, using at least a portion of the second-device PSK shared between the TA and the second device. The TA sends the encrypted first-device PSK to the second device.

According to the seventh aspect, the first device may further encrypt data using the method according to the fifth aspect or any embodiment according to the fifth aspect described above. Herein, the first device uses said at least a portion of the first-device PSK for encrypting the data. Further, the second device may receive the encrypted data from the first device and may decrypt the encrypted data using the method according to the sixth aspect or any embodiment according to the sixth aspect described above. Herein, the second device decrypts said at least a portion of the first-device PSK, using said at least a portion of the second-device PSK. The second device then decrypts the data, using the at least a portion of the first-device PSK.

In an embodiment of the method according to the seventh aspect, encrypting the at least a portion of the first-device PSK comprises the TA encrypting at least one portion of the first-device PSK which the TA has not encrypted and sent to the second device before, i.e., which differs from any portion of the first-device PSK which the TA has previously encrypted and sent to the second device. The first-device PSK is therefore used in a single-use manner to increase the security of the data encryption. After use, the TA may delete the used at least one first portion of the first-device PSK, may replace the used at least one first portion of the first-device PSK with zeros, or may mark the used at least one first portion of the first-device PSK as “used”.

In an embodiment of the method according to the seventh aspect, encrypting the at least a portion of the first-device PSK comprises using the at least a portion of the second-device PSK which the TA has not used for encrypting before. The second-device PSK is used in a single-use manner to increase the security of providing the first-device PSK to the second device.

In an embodiment of the method according to the seventh aspect, the TA provides a new first-device PSK to the first device for replenishing the first-device PSK. The new first-device PSK may be provided to the first device at a trusted physical location. The new first-device PSK may be provided via a device docking station. The TA may provide the new first-device PSK to the first device and/or to the device docking station and/or to the trusted physical location over a quantum network, e.g., using a QKD method.

In an embodiment of the method according to the seventh aspect, there is a plurality of TAs. The first device shares, with each TA of the plurality of TAs, a respective first-device PSK. The second device shares, with each TA of the plurality of TAs, a respective second-device PSK. The method is performed by each TA of the plurality of TAs.

The methods according to the fourth to seventh aspects can be considered as respective parts of a method for securely transmitting data from a first device to a second device according to another aspect of the method.

An eighth aspect of the disclosure provides a method for replenishing a PSK. The PSK is shared between a device and a TA. The device receives a new PSK from the TA. The device combines the new PSK with at least a portion of a pre-existing PSK to generate a replenished PSK shared between the device and the TA.

By having the opportunity of replenishing the PSK, the memory requirements for the device decrease. Further, by combining the new PSK with at least a portion of the current PSK, the trust needed in both the new PSK and in the current PSK reduces.

Key replenishment is particularly important for OTP keys, because OTP keys should not be reused and are irreversibly consumed when used.

In an embodiment of the method according to the eighth aspect, the device stores the new PSK in a memory of the device.

In an embodiment of the method according to the eighth aspect, the device sends a message to the TA, allowing the TA to identify the portion of the pre-existing PSK used to generate the replenished PSK. In this way, the TA can itself create the replenished PSK by combining the new PSK with the identified portion of the pre-existing PSK. The device may inform the TA of used blocks of the pre-existing PSK or of blocks of the pre-existing PSK not yet used.

In an embodiment of the method according to the eighth aspect, the device receives the new PSK from the TA via a non-transitory, computer-readable storage medium storing the new PSK. For example, the new PSK may be physically shipped to the user of the device. The non-transitory, computer-readable storage medium can be a USB flash drive, a CD ROM, a DVD ROM or the like.

In an embodiment of the method according to the eighth aspect, the non-transitory, computer-readable storage medium is physically protected against opening during shipping e.g., by security tape or tamper-evident seal. The non-transitory, computer-readable storage medium may also be (weakly) encrypted with a short amount of the remaining current PSK, e.g., via AES. The new PSK has no value until accepted by the user, so if a breach is detected on route the new PSK can be discarded.

In an embodiment of the method according to the eighth aspect, the device receives the new PSK from the TA over a quantum network, e.g., via a QKD method. Using the QKD method is a secure way of providing the new PSK to the device.

In an embodiment of the method according to the eighth aspect, the device receives the new PSK directly at the user's premises, e.g., through quantum network use of Fibre-To-The-Premises networks. The device might also be a server in a datacenter and might receive the new PSK through quantum fibre networks. The quantum network may employ any quantum key distribution scheme, e.g., the so-called “BB84” protocol which is explained in more detail below.

The device may receive the new PSK via a direct connection or through a device docking station. An advantage of a docking station is that it is not necessary that the device itself is configured to perform QKD methods. It is possible that the device receives the new PSK from the device docking station after the device docking station decodes the new PSK from quantum states received in the QKD method. The device docking station might be located at a trusted physical institution, e.g., a bank branch. The device is connected to a QKD terminal therein.

In an embodiment of the method according to the eighth aspect, the device combines the new PSK with at least a portion of the current PSK, using a privacy amplification method. For example, the new PSK and the portion of the current PSK may be combined using a compression function. The combination of the new PSK with at least a portion of the current PSK can be performed by using a bitwise XOR operation or by using hash functions. Key combination can reduce the trust needed in the new PSK and the pre-existing PSK, independently. This is desirable as the new PSK (if physically shipped) could have been compromised in transmission, and the current PSK could have been compromised as it was stored for a very long time.

In an embodiment of the method according to the eighth aspect, the device provides information to the TA, wherein the information comprises characteristics of the used privacy amplification method, e.g., information characterizing the used compression function to the TA.

In an embodiment of the method according to the eighth aspect, the device provides information to the TA, wherein the information comprises a characterization of the used portion of the current PSK, e.g., a start index and a length of the used portion of the current PSK.

In an embodiment of the method according to the eighth aspect, the device reduces a key length of the replenished PSK. For example, the privacy amplification protocol from QKD can be used to reduce the length of the replenished PSK, and therefore the information eavesdroppers may have. For example, the key may be shortened by a certain percentage per time span, e.g., 5%, 10%, 15%, 20%, or 30% per month.

In an embodiment of the method according to the eighth aspect, the first device performs an authentication process with the TA, allowing said TA to determine that the first device is authorized for PSK replenishment.

A ninth aspect of the disclosure provides a method for replenishing a PSK. The PSK is shared between a device and a TA. The device receives a new PSK at a trusted physical location. In some embodiments, until the new PSK is shared between the device and the TA, the new PSK is exclusively known by the TA. The device generates a replenished PSK shared between the device and the TA, using the received new PSK.

By providing the new PSK at the trusted physical location, trust of the user of the device in the PSK replenishment method may increase. If the location is trusted, i.e. considered secure, manipulation becomes much more difficult for an attacker, thereby increasing the security of the PSK replenishment.

In an embodiment of the method according to the ninth aspect, the trusted physical location is one of a bank, an automated teller machine, a government building, a vending machine provided by the TA or a store associated with the TA.

In an embodiment of the method according to the ninth aspect, the device or a user of the device must go through an authentication procedure at the trusted physical location before the new PSK is provided to the device.

In an embodiment of the method according to the ninth aspect, the device establishes a data connection with a station located at the trusted physical location. The device receives the new PSK via the station. In an embodiment, the station is a device docking station and the device physically connects (e.g., by connecting the first device to a cable or a plug-in interface) with the station to establish data communication with the station. The station may itself store the new PSK in a memory of the station before the new PSK is provided to the device. In another embodiment, the new PSK is passed through the station and provided to the first device without retaining a local copy in a memory of the station.

In an embodiment of the method according to the ninth aspect, the device combines the new PSK with at least a portion of a pre-existing PSK to generate the replenished PSK shared between the device and the TA.

In an embodiment of the method according to the ninth aspect, the device stores the new PSK in a memory of the device.

In an embodiment of the method according to the ninth aspect, the device sends a message to the TA, allowing the TA to identify the portion of the pre-existing PSK used to generate the replenished PSK.

In an embodiment of the method according to the ninth aspect, the device receives the new PSK from the TA via a non-transitory, computer-readable storage medium storing the new PSK.

In an embodiment of the method according to the ninth aspect, the non-transitory, computer-readable storage medium is physically protected against opening during shipping e.g., by security tape. The non-transitory, computer-readable storage medium may also be (weakly) encrypted with a short amount of the remaining current PSK, e.g., via AES.

In an embodiment of the method according to the ninth aspect, the device receives the new PSK from the TA over a quantum network, e.g., using a QKD method.

The device may receive the new PSK via a direct connection or through a device docking station. It is possible that the device receives the new PSK from the device docking station after the device docking station decodes the new PSK from quantum states received over the quantum network.

In an embodiment of the method according to the ninth aspect, the device combines the new PSK with at least a portion of the pre-existing PSK, using a privacy amplification method.

In an embodiment of the method according to the ninth aspect, the device provides information to the TA, wherein the information comprises characteristics of the used privacy amplification method, e.g., information characterizing the compression function used.

In an embodiment of the method according to the ninth aspect, the device provides information to the TA, wherein the information comprises a characterization of the used portion of the current PSK, e.g., a start index and a length of the used portion of the current PSK.

In an embodiment of the method according to the ninth aspect, the device reduces a key length of the replenished PSK. For example, the privacy amplification protocol from QKD can be used to reduce the length of the replenished PSK, and therefore the information eavesdroppers may have. For example, the key may be shortened by a certain percentage per time span, e.g., 5%, 10%, 15%, 20%, or 30% per month.

In an embodiment of the method according to the ninth aspect, the first device performs an authentication process with the TA, allowing said TA to determine that the first device is authorized for PSK replenishment.

A tenth aspect of the disclosure provides a device docking station for replenishing a PSK on a device, wherein the PSK is shared between the device and a TA. The device docking station comprises a processor, a memory, a first interface, and a second interface operable to establish data communication with the device. The processor controls the first interface to receive a new PSK over a quantum network, e.g., using a QKD method, wherein the new PSK is known to the TA. The processor stores the new PSK in the memory. The processor provides the new PSK stored in the memory to the device via the second interface for replenishing the PSK on the device.

According to the method according to the tenth aspect, a new PSK is provided to the device, i.e. a PSK that is previously unknown to the device.

In an embodiment of the device docking station according to the tenth aspect, the device docking station comprises a plurality of second interfaces, connectable to different types of devices for replenishing PSKs on the devices.

In an embodiment of the device docking station according to the tenth aspect, the device docking station is provided at a trusted physical location.

In an embodiment of the device docking station according to the tenth aspect, the first interface is operable to establish a connection with the TA for receiving the new PSK over a quantum network, e.g., using a QKD method. For example, an optical connection with the TA can be established via the first interface, e.g., using fiber optics.

In an embodiment of the device docking station according to the tenth aspect, the processor is configured to perform an authentication method to authenticate the device before providing the new PSK stored in the memory to the device via the second interface for replenishing the PSK on the device.

An eleventh aspect of the disclosure provides a first device for securely transmitting data to a second device. The first device comprises a memory configured to store a plurality of first-device PSKs, wherein each first-device PSK of the plurality of first-device PSKs is shared with a TA of a plurality of TAs. The first device further comprises an interface connected or connectable to the second device and to a plurality of TAs. The interface is configured to receive, from each TA of the plurality of TAs, a respective encrypted second-device PSK of a plurality of second-device PSKs. The second-device PSK is shared between the TA and the second device. The first device further comprises a processor configured to decrypt each encrypted second-device PSK, using the first-device PSK shared with the TA associated with the second-device PSK. The processor generates a key, using the plurality of second-device PSKs decrypted by the first device. The processor encrypts data, using the generated key. The processor controls the interface to send the encrypted data to the second device.

A twelfth aspect of the disclosure provides a second device for securely receiving data from a first device. The second device comprises a memory which stores a plurality of second-device PSKs, wherein each second-device PSK of the plurality of second-device PSKs is shared with a respective TA of a plurality of TAs. The second device further comprises an interface for receiving encrypted data from the first device. A processor decrypts the received encrypted data, using a key generated from the plurality of second-device PSKs.

A thirteenth aspect of the disclosure provides a system for secure data transmission. The system comprises a plurality of TAs and a first device according to the eleventh aspect and configured to communicate with the plurality of TAs. The system further comprises a second device according to the twelfth aspect.

In an embodiment of the system according to the thirteenth aspect, at least one TA of the plurality of TAs comprises a physical random number generator. The at least one TA is configured to generate the first-device PSK shared with the first device and/or the second-device PSK shared with the second device using the physical random number generator. A first-device PSK or a second-device PSK generated with a physical random number generator is practically unpredictable.

In an embodiment of the system according to the thirteenth aspect, at least one TA of the plurality of TAs is configured to pre-store the first-device PSK shared with the first device in the memory of the first device before the first device is packaged or sold and/or to pre-store the second-device PSK shared with the second device in the memory of the second device before the second device is packaged or sold.

In an embodiment of the system according to the thirteenth aspect, at least one TA of the plurality of TAs sends respective encrypted second-device PSKs to each first device of a plurality of first devices, and provides information to the second device allowing the second device to associate a respective first device of the plurality of first devices with each second-device PSK. For example, the TA may indicate the blocks of the PSKs and an ID of the corresponding first device. By providing the information, possible timing issues can be avoided if the TAs serve multiple first devices. E.g., the order in which the second device receives encrypted messages from the first devices may differ from an order in which the TAs send the second device PSKs to the first devices.

In an embodiment of the system according to the thirteenth aspect, the second device decrypts the received encrypted data by generating a further key, wherein the second device is configured to use a same algorithm for generating the further key as the first device for generating the key.

In an embodiment of the system according to the thirteenth aspect, at least one of the TAs is configured to provide a new first-device PSK to the first device for replenishing the first-device PSK shared with said TA. In addition or alternatively, the TA may provide a new second-device PSK to the second device for replenishing the second-device PSK shared with said TA. The TA may use a quantum network, e.g., using a quantum key distribution, QKD, method to provide the new first-device PSK to the first device and/or to provide the new second-device PSK to the second device.

A fourteenth aspect of the disclosure provides a first device for securely transmitting data to a second device. The first device comprises a memory storing at least one first-device PSK. The at least one first-device PSK is shared with a corresponding at least one TA. A processor encrypts data, using the at least one first-device PSK. An interface is connected or connectable to the at least one TA and to the second device. The encrypted data is sent to the second device via the interface. A request message is sent via the interface to the at least one TA, requesting the at least one TA to send at least a portion of the at least one first-device PSK to the second device. The at least one first-device PSK is to be encrypted by the at least one TA using a second-device PSK shared between the at least one TA and the second device.

A fifteenth aspect of the disclosure provides a second device for securely receiving data from a first device. The second device comprises a memory storing a second-device PSK. The second-device PSK is shared with a TA. An interface is connected or connectable to the first device and the TA. Encrypted data is received from the first device via the interface. An encrypted first-device PSK is received via the interface from the TA. The first-device PSK is shared between the first device and the TA. A processor decrypts the received encrypted first-device PSK, using the second-device PSK. The processor decrypts the received encrypted data, using the decrypted first-device PSK.

A sixteenth aspect of the disclosure provides a system for secure data transmission. The system comprises a first device according to the fourteenth aspect. The system further comprises a second device according to the fifteenth aspect.

The invention relates to all combinations of the above features, even if these are recited in different claims.

Further, if the embodiments have been described by comprising the transmission of data from the first device to the second device, only, the invention is generally also applicable to bidirectional communication. That is, the second device may also transfer data to the first device, e.g., using one of the communication methods described above. The first device and the second device may also communicate with different communication methods, e.g., each device uses a communication method according to a different aspect of the invention for transmitting data to the respective other device.

### BRIEF DESCRIPTION OF THE DRAWINGS

In the following, further aspects and exemplary embodiments will be described with reference to the accompanying drawings. However, the present invention is not limited to the described exemplary embodiments and may be modified in various different ways. Consequently, the drawings and description are intended to be illustrative in nature and not limiting. Identical reference numbers denote identical elements in the specification.

FIG. 1 schematically shows a block diagram illustrating a system for secure data transmission according to an embodiment of the invention;

FIG. 2 schematically shows a block diagram illustrating a first device according to an embodiment of the invention;

FIG. 3 schematically shows a block diagram illustrating a second device according to an embodiment of the invention;

FIG. 4 schematically shows a block diagram illustrating a trusted authority according to an embodiment of the invention;

FIG. 5 schematically shows a block diagram illustrating a device docking station according to an embodiment of the invention;

FIG. 6 shows a flow diagram illustrating a method for supporting secure transmittal of data from a first device to a second device according to an embodiment of the invention;

FIG. 7 shows a flow diagram illustrating a method for securely transmitting data from a first device to a second device according to an embodiment of the invention;

FIG. 8 shows a flow diagram illustrating a method for securely transmitting data from a first device to a second device according to an embodiment of the invention;

FIG. 9 shows a flow diagram illustrating a method for securely receiving data from a first device by a second device according to an embodiment of the invention;

FIG. 10 shows a flow diagram illustrating a method for securely transmitting data from a first device to a second device according to an embodiment of the invention;

FIG. 11 shows a flow diagram illustrating a method for securely receiving data from a first device by a second device according to an embodiment of the invention;

FIG. 12 shows a flow diagram illustrating a method for supporting secure transmittal of data from a first device to a second device according to an embodiment of the invention;

FIG. 13 shows a flow diagram illustrating a method for replenishing a PSK according to an embodiment of the invention; and

FIG. 14 shows a flow diagram illustrating a method for replenishing a PSK according to an embodiment of the invention.

### DETAILED DESCRIPTION OF THE INVENTION

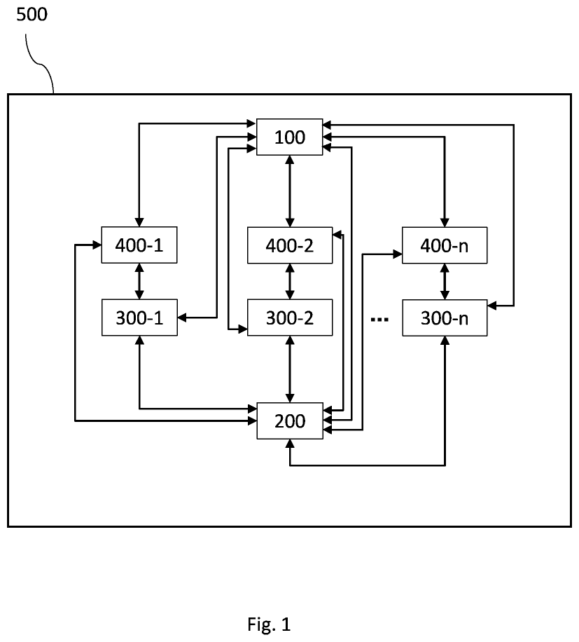

FIG. 1 schematically shows a block diagram illustrating a system 500 for secure data transmission. The system 500 comprises a first device 100, a second device 200, and TAs 300-1 to 300-n, where n denotes the total number of TAs. In some embodiments of the system 500, there can be a single TA, i.e., n=1. In other embodiments, the system 500 may comprise two TAs, i.e., n=2, or may comprise at least three TAs, i.e., n>2.

Further, the system 500 comprises a plurality of n device docking stations 400-1 to 400-n. Herein, exactly one device docking station 400-1 to 400-n may be provided for each TA 300-1 to 300-n. In other embodiments, the number of device docking stations 400-1 to 400-n may be smaller or larger than the number of TAs, or the device docking stations 400-1 to 400-n may be absent.

The first device 100 and the second device 200 may each be any one of a personal computer, a mobile phone, a tablet computer, a personal digital assistant, a wearable electronic device, a virtual reality device, a robot, an industrial device, a smart vehicle, and the like. The first device 100 and/or the second device 200 may also be a server, e.g. in a data center. In particular, the first device 100 and the second device 200 can be a user device but in other embodiments they need not be human-operated devices. The first device 100 and/or the second device 200 may also be any portable or non-portable electronic device.

The term “TA” (trusted authority) is used for a computing system of a third party trusted to distribute keys between the first device 100 and the second device 200. In the case of multiple TAs, all of the TAs may be operated by the same third party or at least some of the TAs may be operated by different third parties.

The first device 100 communicates directly with the second device 200 over a data connection which can comprise a public channel in some embodiments. Each of the first device 100 and the second device 200 also communicates with each of the TAs 300-1 to 300-n over respective channels, which can comprise public channels in some embodiments.

Further, the first device 100, the second device 200 and the TAs 300-1 to 300-n can each connect to the device docking station 400-1 to 400-n over respective channels, which can comprise trusted channels in some embodiments. In an embodiment, each TA 300-1 to 300-n can only connect to an associated one of the device docking stations 400-1 to 400-n.

The first device 100, the second device 200, the TAs 300-1 to 300-n and the device docking stations 400-1 to 400-n are configured for one-directional or bidirectional transmission of data over the respective channels, e.g., via electrical and/or optical connections, WLAN interfaces, Bluetooth interfaces, Ethernet interfaces, or the like.

The first device 100, the second device 200, the TAs 300-1 to 300-n and the device docking stations 400-1 to 400-n can be arranged in a client/server-architecture, communicating through a communication network, e.g., a local area network (LAN), the internet or a peer-to-peer (P2P) network. For example, the TAs 300-1 to 300-n may act as remote servers, transmitting data to the first device 100, the second device 200 and the device docking stations 400-1 to 400-n, acting as clients.

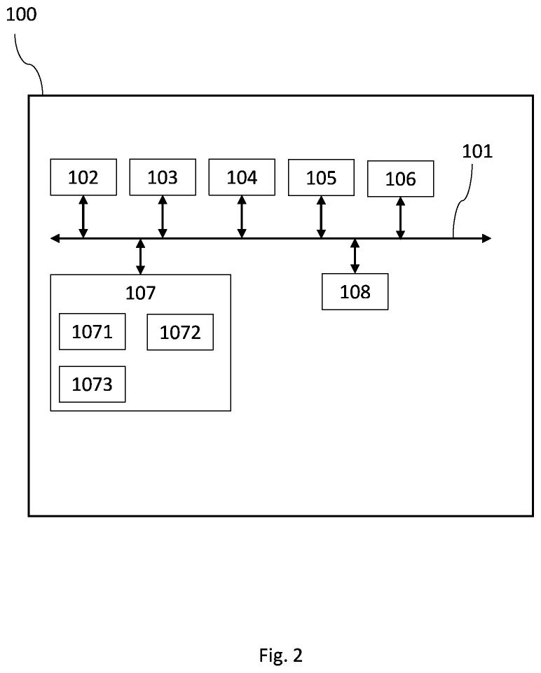

Possible embodiments of the first device 100, the second device 200, the TAs 300-1 to 300-n and the device docking stations 400-1 to 400-n are now explained in more detail with reference to FIGS. 2 to 5.

FIG. 2 schematically shows a block diagram illustrating a first device 100. The first device 100 comprises a memory 102. The memory 102 can comprise at least one of a magnetic hard disk, an optical disc (e.g., compact disc, digital video disc, Blu-ray disc), a solid state disc (SSD), a magneto-optical memory or a hard disc drive (HDD). For example, the memory 102 can comprise a volatile semiconductor or solid state memory, e.g., a random access memory (RAM), dynamic RAM (DRAM), or static RAM (SRAM). The memory 102 can comprise a non-volatile semiconductor or solid state memory, e.g., a read only memory (ROM), programmable ROM (PROM), erasable PROM (EPROM), or the like.

The memory 102 stores processor-executable instructions and/or processor-readable data associated with the operation of the first device 100. The processor-executable instructions and/or processor-readable data can comprise an operating system, peripheral drivers, server instructions, application instructions, calibration instructions, or communication channel instructions.

The memory 102 particularly stores at least one first-device PSK shared with the at least one TA 300-1 to 300-n. If there is a plurality of TAs 300-1 to 300-n, a respective first-device PSK is shared with each TA 300-1 to 300-n. The first device 100 is secure to avoid that the at least one first-device PSK is compromised.

The first device 100 further comprises a communication interface 103 connected or connectable to the second device 200 and the TAs 300-1 to 300-n, and a docking station interface 104 connected or connectable to the device docking stations 400-1 to 400-n. In other embodiments, there can be a single interface connected or connectable to all of the second device 200, the TAs 300-1 to 300-n, and the device docking stations 400-1 to 400-n.

The communication interface 103 comprises communication circuitry for bidirectional communication with the second device 200 and the TAs 300-1 to 300-n over a connection, e.g., an internet connection, a serial connection, a parallel connection, an ethernet connection, a wireless connection, a fiber optic connection or the like. The communication interface 103 may employ communication protocols such as FTP, HTTPS, SSH or TCP/IP to communicate.

The communication interface 103 may comprise different interfaces for communication with the second device 200 and for communication with the TAs 300-1 to 300-n. For example, the first device 100 may communicate with the TAs 300-1 to 300-n over the internet, while the first device 100 communicates with the second device 200 over a private network. In some embodiments, the communication interface 103 of the first device 100 only comprises a transmitter interface for transmitting data to the second device 200 but does not comprise a receiver interface for receiving data from the second device 200. In these embodiments, the first device 100 communicates with the second device 200 in a one-directional way. In other embodiments, the communication interface 103 enables bidirectional communication between the first device 100 and the second device 200, i.e., comprises both a receiver interface and a transmitter interface. For example, the first interface 103 may comprise a communication circuitry for bidirectional communication with the second device 200 and the TAs 300-1 to 300-n over a network connection.

The docking station interface 104 can comprise circuitry for directly connecting to the device docking stations 400-1 to 400-n, e.g., via a cable connection, such as a USB connection.

The first device 100 further comprises an input device 105 for user input, which may comprise at least one of a keyboard, a pointing device such as a mouse or trackball, a number pad, a touch screen, a button, a switch and a microphone.

The first device 100 further comprises an output device 106 for user output, which may comprise at least one of a display device, e.g., a monitor for presenting information to the user, or loudspeakers. The output device 106 may provide sensory feedback, e.g., visual feedback, tactile feedback or auditory feedback.

The first device 100 further comprises a processor 108 which is a logic processing unit and can comprise a central processing unit (CPU), a graphics processing unit (GPU), a microcontroller, an integrated circuit (IC), an application-specific integrated circuit (ASIC), a digital signal processor (DSP), a field programmable gate array (FPGA), a program logic unit (PLU), a network processor (NP) or a combination thereof.

The first device 100 comprises a QKD module 107 connectable or connected to the TAs 300-1 to 300-n and/or to the device docking stations 400-1 to 400-n.

The first device 100 can establish a connection for quantum key distribution with at least one of the TAs 300-1 to 300-n and/or the device docking stations 400-1 to 400-n via the QKD module 107.

For QKD, communicating parties exchange information encoded in quantum states over a quantum channel, e.g., an optical channel. Multiple quantum key distribution schemes are known and the invention is not restricted to any particular scheme. An exemplary scheme is so-called “BB84” which will be outlined in the following.

The first device 100 is configured to send a private key to one of the TAs 300-1 to 300-n and/or to the device docking stations 400-1 to 400-n (i.e., a communication partner). The QKD module 107 comprises a true random number generator (TRNG) 1071 (a physical random number generator) for generating a first bit string a of length (4+δ)·n, where n is a positive integer and δ is a positive number. The TRNG 1071 further generates a second bit string b of length (4+δ)·n. The first bit string a and the second bit string b are stored in the memory 102.

A quantum state encoder 1072 encodes each bit 0 or 1 of the first bit string a as

$$\vert 0 〉 or \vert 1 〉 ,$$

respectively, if the corresponding bit of the second bit string b is equal to 0, or as

$$\vert + 〉 = \frac{1}{√ 2} ( \vert 0 〉 + \vert 1 〉 ) or \vert - 〉 = \frac{1}{√ 2} ( \vert 0 〉 - \vert 1 〉 ) ,$$

respectively, if the corresponding bit of the second bit string b is equal to 1. Herein, |0 [symbol] and |1 [symbol] are the two states of a qubit, i.e., a two-state quantum-mechanical system. The quantum state encoder 1072 may realize the qubit states in any suitable physical implementation, comprising but not restricted to photon polarization, photon number, time-bin encoding using photons, electron spin, electron number, electron localization in quantum dot pairs, dot spin, nuclear spin, atomic spin, superconducting charge, superconducting flux, superconducting phase, vibrational states, or non-abelian anyons.

The encoded quantum states are provided to the communication partner via the QKD interface 1073 of the QKD module 107. For example, each quantum state may be a polarization state of a photon and the QKD interface 1073 comprises optical fibers for transporting the photon to the communication partner.

The communication partner receives the (4+δ)·n qubits, and announces the receipt to the first device (e.g., over a public channel, for example involving communication interface 103). Loss of the channel can also be taken into account. In this case, the TRNG 1071 generates the first bit string a with a length being greater than (4+δ)·n, e.g. by a factor which is selected such that the communication partner receives on average at least (4+δ)·n qubits.

The communication partner generates a third random bit string b′ of length (4+δ)·n, e.g., using a physical random number generator. A quantum state decoder of the communication partner decodes each bit 0 or 1 of the received quantum state in the basis {|0 [symbol] , |1 [symbol] }, if the corresponding bit of the third random bit string b′ is equal to 0 or in the basis {|+ [symbol] , |− [symbol] }, if the corresponding bit of the third random bit string b′ is equal to 1, and thereby generates a fourth bit string a′.

The first device 100 announces the second bit string b, i.e., the basis in which the qubits were prepared. For announcing the second bit string b, the first device may use the communication interface 103. The communication partner communicates with the first device over the public channel (e.g., involving the network device 103) to determine which bits of the second random bit string b and the third random bit string b′ do not match. The first device 100 and the communication partner discard the corresponding bits of the first bit string a and the fourth bit string a′. With high probability, there are at least 2n bits left in the first bit string a and the fourth bit string a′. Otherwise, the protocol is aborted and repeated.

The processor 108 selects a subset of n bits of the first bit string a that will serve as a check on interference which might be caused by an eavesdropper. The first device 100 communicates with the communication partner over a public channel (e.g., involving the network device 103) and informs the communication partner of the selected bits. The first device 100 and the communication partner compare the values of the selected bits. If more than an acceptable predefined number of the values disagree, the protocol is aborted. Otherwise, the first device 100 and the communication partner perform information reconciliation and privacy amplification on the remaining bits to obtain shared key bits. Information reconciliation corresponds to an error correction to ensure that both keys are identical. For information reconciliation, the so-called cascade protocol may be used. Privacy amplification refers to the reduction of the partial information of a potential eavesdropper. A shorter new key is produced, e.g., using a universal hash function, chosen at random from a publicly known set of universal hash functions.

In the description above, the QKD module 107 has been described to prepare the quantum states. In further embodiments, the QKD module 107 may additionally or alternatively be configured to play the role of the communication partner. In particular, the QKD module 107 may comprise a receiver (not shown) for receiving the transmitted quantum state and a quantum state decoder (not shown) for decoding the received quantum state.

Many variations and generalizations of the BB84 protocol are known and may be used by the QKD module 107. Another important protocol is the so-called “E91”-protocol which uses entangled pairs of photons. Any other QKD scheme might be employed by the QKD module 107 as well.

All of the components of the first device 100 described above can be controlled and/or can communicate over at least one bus 101. The processor 108 may be configured to control the other above-described components 101 to 107 of the first device 100. In some embodiments, at least some of the components 101 to 107 may be arranged in subsystems.

The processor 108 is configured to generate a key and to encrypt data, using the key. The encrypted data is provided to the second device 200, e.g., using the communication interface 103. For encrypting the data, the processor 108 may use the at least one first-device PSK.

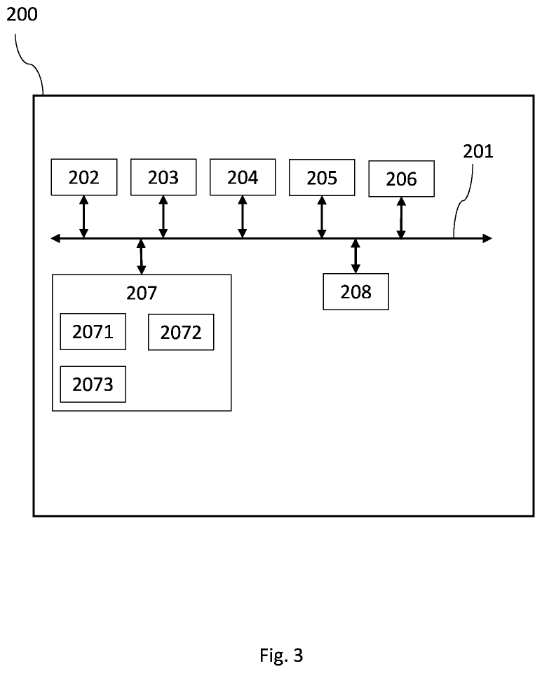

FIG. 3 schematically shows a block diagram illustrating a second device 200. The second device comprises at least one bus 201, a memory 202, a communication interface 203, a docking station interface 204, an input device 205, an output device 206, a processor 208, and a QKD module 207 (having a TRNG 2071, a quantum state encoder 2072, and a QKD interface 2073). All of these components may be configured like the corresponding components of the first device 100 described above with reference to FIG. 2. Accordingly, a detailed description of these components can be omitted.

Even if both the first device 100 and the second device are configured for QKD methods, it can be advantageous to communicate via intermediary TAs. If there are many users (i.e. first and second devices), having each user communicate directly with every other user, requires approximately N² connections. By using n intermediary TAs, the number of connections can reduce to 2·n·N, which can be much less than N².

In contrast to the memory 102 of the first device 100, the memory 202 of the second device 200 stores a plurality of second-device PSKs. Each second-device PSK of the plurality of second-device PSKs is shared with a respective TA 300-1 to 300-n.

Further, in some embodiments, the communication interface 203 of the first device 200 only comprises a receiver interface for receiving data from the first device 100 but does not comprise a transmitter interface for transmitting data to the first device 100. In these embodiments, the first device 100 communicates with the second device 200 in a one-directional way. In other embodiments, the communication interface 203 enables bidirectional communication between the first device 100 and the second device 200.

Further, the processor 208 is configured to decrypt encrypted data received from the first device 100, using the plurality of second-device PSKs.

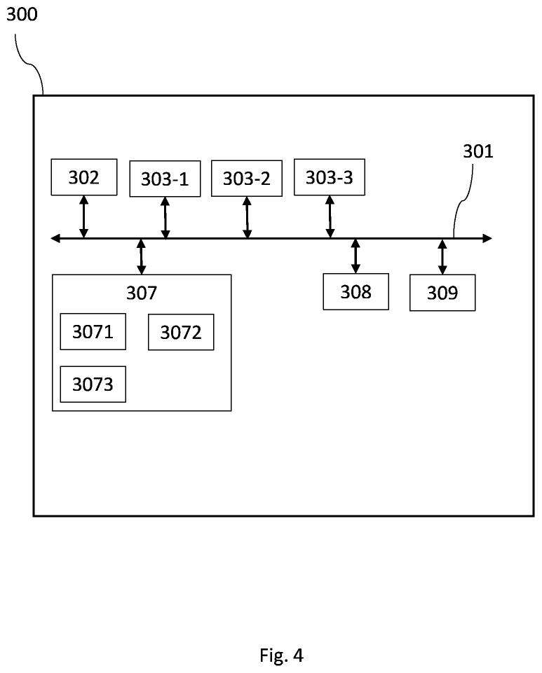

FIG. 4 schematically shows a block diagram illustrating a trusted authority, TA, 300, which can be any of the TAs 300-1 to 300-n shown in FIG. 1.

The TA 300 is a communication device which comprises at least one bus 301, a memory 302, a first communication interface 303-1, a second communication interface 303-2, a third communication interface 303-3, a processor 308, and a QKD module 307 (having a TRNG 3071, a quantum state encoder 3072, and a QKD interface 3073). All of these components may be configured like the corresponding components of the first device 100 or second device 200 described above with reference to FIGS. 2 and 3, wherein each of the first communication interface 303-1, the second communication interface 303-2, and the third communication interface 303-2 corresponds to the communication interface 103 or 203 of the first device 100 or second device 200, respectively. Accordingly, a detailed description of these components can be omitted.

In addition, the first interface 303-1 is arranged for communication with the first device 100. The second communication interface 303-2 is arranged for communication with the second device 200. The third communication interface 303-3 is arranged for communication with the device docking stations 400-1 to 400-n.

In contrast to the memory 102 of the first device 100, the memory 302 of the TA 300 stores both a plurality of first-device PSKs shared with the first device 100 and a plurality of second-device PSKs shared with the second device 200.

The TA 300 further comprises another TRNG 309. The processor 308 generates the first-device PSK shared with the first device and/or the second-device PSK shared with the second device using the physical random number generator 309. After generating the first-device PSK, the first-device PSK is provided to the first device 100 via the first communication interface 303-1 over an authenticated channel. After generating the second-device PSK, the second-device PSK is provided to the second device 200 via the second communication interface 303-2 over an authenticated channel.

In further embodiments, the TA 300 comprises a single TRNG, used for both generating the first-device PSK and/or the second-device PSK and for QKD methods.

In further embodiments, the TA 300 may comprise only one or two interfaces for communication with the first device 100, the second device 200 and the device docking stations 400-1 to 400-n.

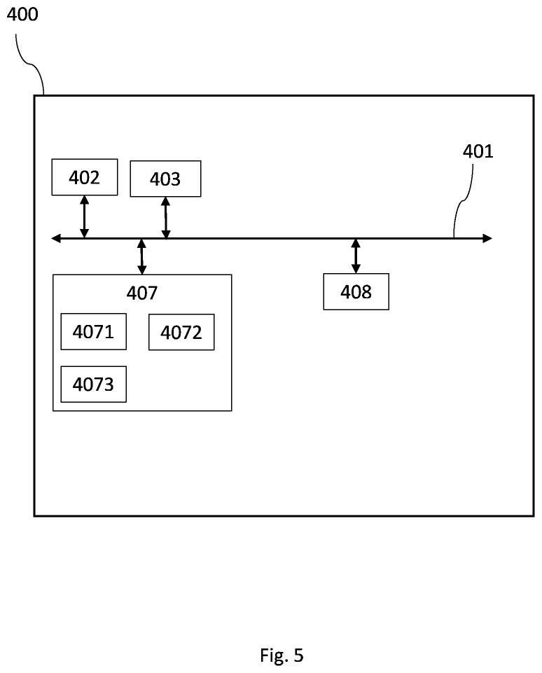

FIG. 5 schematically shows a block diagram illustrating a device docking station 400 for replenishing a PSK on a device (e.g., the first device 100 or second device 200). The PSK is shared between the device and a TA (e.g., the TA 300). The device docking station 400 can be any of the device docking stations 400-1 to 400-n of the system in FIG. 1.

The device docking station 400 comprises at least one bus 401, a memory 402, QKD module 407 (having a TRNG 4071, a quantum state encoder 4072, and a QKD interface 4073 which is a first communication interface), a second communication interface 403, and a processor 408. All of these components may be configured like the corresponding components of the first device 100 or second device 200 described above with reference to FIGS. 2 and 3, wherein the second communication interface 403 corresponds to the communication interface 103 or 203 of the first device 100 or second device 200, respectively. Accordingly, a detailed description of these components can be omitted.

In addition, the QKD interface 4073 (i.e., first communication interface) is arranged for receiving a new PSK by a QKD method. The second communication interface 403 is arranged for communication with the device.

The processor 408 controls the first interface 4073 to receive the new PSK by a QKD method, using the QKD module 407. The new PSK may be received from a server (e.g. operated by a trusted third party) or from a TA 300-1 to 300-n. In some embodiments, until the new PSK is received by the device (e.g. 100 or 200) the new PSK is exclusively known by the TA 300-1 to 300-n. The processor 408 stores the new PSK in the memory 402. The processor 408 provides the new PSK stored in the memory 402 to the device via the second interface 403 for replenishing the PSK on the device.

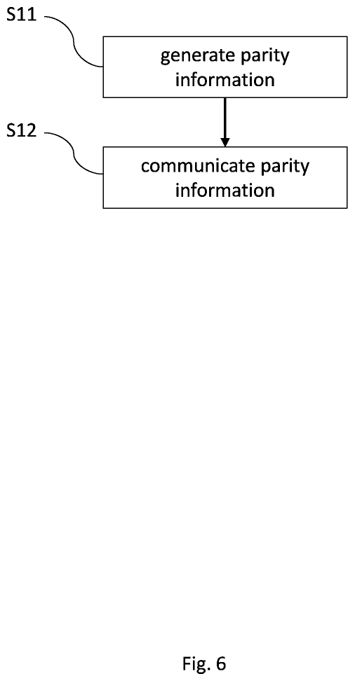

FIG. 6 shows a flow diagram illustrating a method for supporting secure transmittal of data from a first device to a second device. Herein, the first device 100 can be configured as described in the context of FIG. 2. The second device 200 can be configured as described in the context of FIG. 3. The data may be transmitted over a system 100 as described in the context of FIG. 1. The system can comprise a single TA 300-1 to 300-n or can comprise a plurality of TAs 300-1 to 300-n. In the following, the case of multiple TAs 300-1 to 300-n will be described, the case of a single TA 300-1 to 300-n being easily understood.

The first device 100 and each TA 300-1 to 300-n of a plurality of TAs 300-1 to 300-n share a respective first-device PSK of a plurality of first-device PSKs. Further, the second device 200 and each TA 300-1 to 300-n of the plurality of TAs 300-1 to 300-n share a respective second-device PSK of a plurality of second-device PSKs.

In a first step S11, each TA 300-1 to 300-n generates parity information between corresponding first-device PSK and second-device PSK. The TA 300-1 to 300-n may generate the parity information by applying bitwise XOR to the first-device PSK and the second-device PSK. For example, the first-device PSK may comprise the bit sequence 0010101 and the second-device PSK may comprise the bit sequence 0111011. The TA 300-1 to 300-n computes the parity information PI (corresponding to said bit sequences) as follows:

$$PI = 0010101 ⊕ 0111011 = 101110.$$

In a second step S12, the TA 300-1 to 300-n communicates the parity information to the first device 100 and/or to the second device 200. The TA 300-1 to 300-n can communicate the parity information publicly or privately. The TA 300-1 to 300-n may also use a QKD method to communicate the parity information.

In some embodiments, the first device 100 may first send a request message to each TA 300-1 to 300-n, requesting the TA 300-1 to 300-n to support secure transmittal of data from the first device to the second device. The TA 300-1 to 300-n will then perform steps S11 and S12.

In further embodiments, the first device 100 performs an authentication process with the TA 300-1 to 300-n before step S11.

The TA 300-1 to 300-n may also deliver a new first-device PSK to the first device 100 for replenishing the first-device PSK shared between the TA and the first device 100.

After the first device 100 receives the parity information from the TAs 300-1 to 300-n, the first device 100 may perform bitwise XOR between the first-device PSKs and the corresponding parity information, thereby effectively deducing the second-device PSKs. The first device 100 generates a key by applying a bitwise XOR to the deduced second-device PSKs, encrypts data using the key, and sends the encrypted data to the second device 200. The second device 200 generates a similar key by applying bitwise XOR to the second-device PSKs in its possession, and decrypts the data using the key. As will be appreciated, because a bitwise XOR is a logical operation on bits, it follows that the TAs 300-1 to 300-n, first device 100, and second device are operable to perform logical operations on binary information.

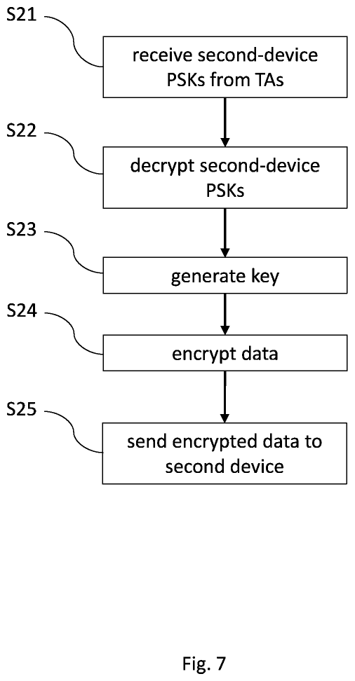

FIG. 7 shows a flow diagram illustrating a method for securely transmitting data from a first device to a second device. Herein, the first device 100 can be configured as described in the context of FIG. 2. The second device 200 can be configured as described in the context of FIG. 3. The data may be transmitted over a system 100 as described in the context of FIG. 1.

The first device 100 shares with each TA 300-1 to 300-n of a plurality of TAs 300-1 to 300-n a respective first-device PSK of a plurality of first-device PSKs. The plurality of TAs 300-1 to 300-n may comprise at least three TAs 300-1 to 300-n with corresponding at least three first-device PSKs. The first device 100 may receive at least one of the first-device PSKs from the corresponding TA of the plurality of TAs 300-1 to 300-n by a QKD method, using the QKD module 107 of the first device 100 and the QKD module 307 of the TAs 300-1 to 300-n. The first device 100 stores the at least one received first-device PSK in the memory 102 of the first device 100.

In other embodiments, the first device 100 receives at least one of the first-device PSKs before the first device 100 is packaged or sold. For example, the first-device PSK may be stored in the memory 102 of the first device 100 during manufacturing the first device 100.

In step S21, the first device 100 sends a request to each TA 300-1 to 300-n, informing the TAs 300-1 to 300-n that it wishes to communicate with the second device 200. In response to the request, the first device 100 receives from each TA 300-1 to 300-n a respective encrypted second-device PSK of a plurality of second-device PSKs. The second-device PSK is shared between the TA 300-1 to 300-n and the second device 200.

Before receiving the encrypted second-device PSK, the first device 100 may first perform an authentication process with the corresponding TA 300-1 to 300-n. For example, the first device 100 may send a request to the TA 300-1 to 300-n that it wishes to communicate with the second device 200. The TA 300-1 to 300-n receives the request and runs an authentication protocol to verify the identity of the first device 100 and to establish that the first device 100 is authorized to communicate with the second device 200. The authentication process may use a classical authentication protocol, e.g., password-based or public-key authentication.

Further, before receiving the encrypted second-device PSK, the first device 100 may send a request message to the TA 300-1 to 300-n, indicative of a size of the respective second-device PSK sufficient for generating a key. The sufficient key size may depend on the scheme for generating the key. For example, the size of the second-device PSK may be at least as large as the size of the data to be encrypted and transmitted to the second device 200, e.g., if OTP is used.

In step S22, the first device 100 decrypts each encrypted second-device PSK, using the first-device PSK shared with the TA 300-1 to 300-n associated with the second-device PSK. That is, the TA 300-1 to 300-n has previously encrypted each second-device PSK with the respective first device PSK shared with the first device 100.

In step S23, the first device 100 generates the key, using the plurality of second-device PSKs decrypted by the first device 100. For example, the first device 100 computes a function of the second-device PSKs of the plurality of second-device PSKs. The generated key differs from any one of the individual second-device PSKs of the plurality of second-device PSKs.

In step S24, the first device 100 uses the generated key to encrypt data.

Encryption is a process that scrambles readable text so it can only be read by the person who has the secret code, or decryption key. It helps to provide data security for sensitive information. Encryption works by taking plain text, like a text message or email, and scrambles it into an unreadable format, the “cipher text.” This helps protect the confidentiality of digital data either stored on computer systems or transmitted through a network like the Internet. For encryption, the first device 100 may use any symmetric encryption scheme, such as Data Encryption Standard (DES), Advanced Encryption Standard (AES), and Twofish.

In one embodiment, the first device 100 may use an OTP scheme for encrypting the data. In this symmetric encryption scheme, (at least a portion of) the generated key is used, having a length being at least as large as the length of the data to be encrypted.

In some embodiments, the generated key is truly random. This might be achieved if the TA 300 uses the TRNG 309 to generate the second-device PSKs. The TA 300 may also use quantum random number generators. Encrypting data with keys based on randomness has the advantage that there is theoretically no way to break the code by analyzing a succession of messages. In other embodiments, the TA 300 uses protocols that tolerate some bad randomness.

In step S25, the first device 100 sends the encrypted data to the second device.

As a specific example, in an embodiment there are two TAs 300-1 and 300-2, and each TA 300-1, 300-2 shares a respective first-device PSK K_{A1} and K_{A2} with the first device 100 and a respective second-device PSK K_{B1} and K_{B2} with the second device 200. The PSKs K_{A1}, K_{A2}, K_{B1}, K_{B2} may be preloaded to the first device 100 and second device 200, respectively, or preloaded to one of the first device 100 and second device 200 and loaded via QKD or physical shipment to the other of the first device 100 and the second device 200. In one embodiment, only PSKs of one of the TAs 300-1 and 300-2 (e.g. the PSKs K_{A1}, K_{B1} of the first TA 300-1) are preloaded and the PSKs of the other TA 300-1 and 300-2 (e.g. the PSKs K_{A2}, K_{B2} of the second TA 300-2) are provided at a later time. In other embodiments, PSKs K_{A1}, K_{A2}, K_{B1}, K_{B2} from more than one TA 300-1 and 300-2 are preloaded or PSKs K_{A1}, K_{A2}, K_{B1}, K_{B2} from more than one TA 300-1 and 300-2 are provided at a later time.

The first TA 300-1 uses its first-device PSK K_{A1} as an OTP to encrypt its second-device PSK key K_{B1}, i.e., according to the following formula:

$${K}_{AB 1} = {K}_{A 1} ⊕ {K}_{B 1} ,$$

where ⊕ indicates bitwise XOR. Herein, K_{AB1} denotes the encrypted second-device PSK key K_{B1} shared between the second device 200 and the first TA 300-1.

The second TA 300-2 uses its own first-device PSK K_{A2} as an OTP to encrypt its own second-device PSK key K_{B2}, i.e., according to the following formula:

$${K}_{AB 2} = {K}_{A 2} ⊕ {K}_{B 2} .$$

Herein, K_{AB2} denotes the encrypted second-device PSK key K_{B2} shared between the second device 200 and the second TA 300-2.

Each of the first TA 300-1 and the second TA 300-2 sends its respective combined key K_{AB1} Or K_{AB2}, i.e., the encrypted second-device PSK, to the first device 100.

The first device 100 decrypts both encrypted second-device PSKs and combines them to generate the key, i.e., according to the following formula:

$${K}_{B 12} = ( {K}_{AB 1} ⊕ {K}_{A 1} ) ⊕ ( {K}_{AB 2} ⊕ {K}_{A 2} ) = {K}_{B 1} ⊕ {K}_{B 2} .$$

The first TA 300-1 and the second TA 300-2 independently communicate an identifier to the second device 200, e.g., a start index and a length of the PSK, of the respective second-device PSK that was used during communication with the first device 100. This information allows the second device 200 to identify the two second-device PSKs K_{B1}, K_{B2} that have been used by the first TA 300-1 and the second TA 300-2, respectively.

The second device 200 combines its two second-device PSKs to output

$${K}_{B 12} = {K}_{B 1} ⊕ {K}_{B 2} .$$

The order of combining the second-device PSK does not matter since they are all combined with an XOR operation. For example, the PSKs may be used in the order that the second-device PSKs are stored in memory.

Neither the first TA 300-1 nor the second TA 300-2 (acting independently) has knowledge of the final key K_{B12} independently, as it has been combined with a fully random key unknown to that TA 300-1, 300-2. The first device 100 and the second device 200 use the combined key K_{B12} for OTP encryption, for transmitting data from the first device 100 to the second device 200 or for transmitting data from the second device 200 to the first device 100.

The process can be extended to an arbitrary number of TAs, combining keys similarly by bitwise XOR.

The first device 100 may discard keys after use. That is, the first-device PSKs may be single-use PSKs. This may involve including a requirement in the key management software and encryptor of the first device 100 to securely delete PSKs after use. For example, the processor 108 may control the memory 102 to overwrite the corresponding portion in the memory 102 with zeros.

Further, in some embodiments, the second-device PSKs can be single-use PSKs as well.

In some embodiments, the first device 100 may replenish the first-device PSKs shared with the TAs 300-1 to 300-n. For example, the first device 100 may determine that the size of a first-device PSK stored in memory is less than a predefined threshold value. The first device 100 requests the corresponding TA 300-1 to 300-n to replenish the corresponding first-device PSK. The TA 300-1 to 300-n provides a new first-device PSK to the first device 100 for replenishing the first-device PSK shared with the TA 300-1 to 300-n. In other embodiments, the TA 300-1 to 300-n keeps track of the size of the first-device PSK shared with the first device 100. If the TA 300-1 to 300-n determines that the size of the first-device PSK is less than the predefined threshold value, the TA informs the first device 100 and provides a new first-device PSK to the first device 100 for replenishing the first-device PSK shared with the TA 300-1 to 300-n.

In an embodiment, the TA 300-1 to 300-n will provide the new PSK to the first device 100 via a private channel.

In another embodiment, the first device 100 receives the new first-device PSK at a trusted physical location. The first device 100 may establish a data connection with a station located at the trusted physical location. The first device 100 then receives the new first-device PSK via the station. For example, the station can be a device docking station 400 and the first device 100 may be physically connected to the device docking station 400, e.g., using a cable connection.

In another embodiment, the first device 100 receives the new first-device PSK from the TA 300-1 to 300-n via a QKD method, using the QKD module 107 of the first device and the QKD module 307 of the TA 300-1 to 300-n. The first device 100 may combine the new first-device PSK with at least a portion of the pre-existing first-device PSK, using a privacy amplification method.

In another embodiment, the first device 100 provides information to the TA 300-1 to 300-n, wherein the information comprises characteristics of the used privacy amplification method and/or a characterization of the used portion of the current first-device PSK.

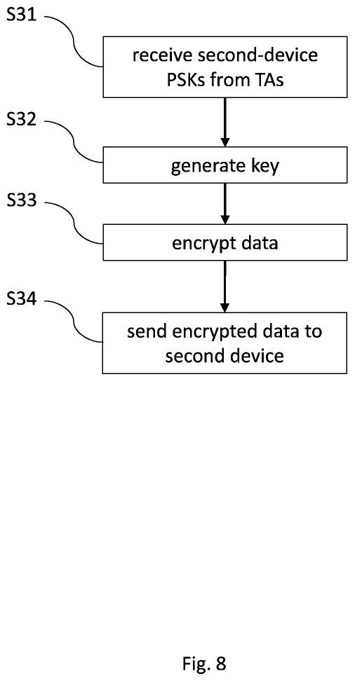

FIG. 8 shows a flow diagram illustrating a method for securely transmitting data from a first device 100 to a second device 200.

In a step S31, the first device 100 receives a respective second-device PSK of a plurality of second-device PSKs from each TA 300-1 to 300-n of a plurality of TAs 300-1 to 300-n. The second-device PSKs are shared between the corresponding TA 300-1 to 300-n and the second device 200.

In a step S32, the first device 100 generates a key, using the plurality of second-device PSKs.

In step S33, the first device 100 encrypts data, using the generated key.

In step S34, the first device 100 sends the encrypted data to the second device 200.

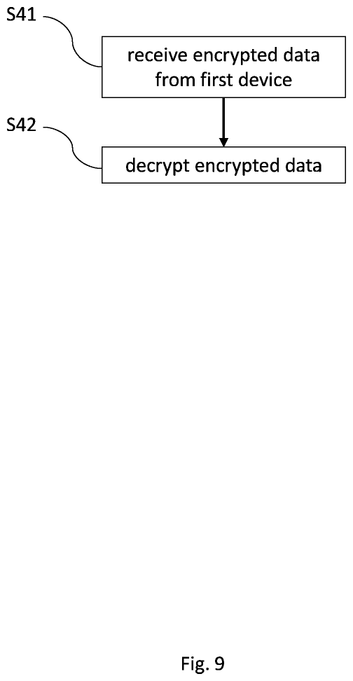

FIG. 9 shows a flow diagram illustrating a method for securely receiving data from a first device 100 by a second device 200. The second device 200 shares with each TA 300-1 to 300-n of a plurality of TAs 300-1 to 300-n a respective second-device PSK of a plurality of second-device PSKs.

In a step S41, the second device 200 receives encrypted data from the first device 100. The first device may have encrypted the data using the method described above with reference to FIG. 7 or 8.

In a step S42, the second device 200 decrypts the received encrypted data, using the plurality of second-device PSKs. The second device 200 may generate a key, using each second-device PSK of the plurality of second-device PSKs. The second device uses the generated key to decrypt the received encrypted data.

In an embodiment, the second device 200 may receive information from each TA 300-1 to 300-n characterizing a portion of the second-device PSK which the second device 200 should use for generating the key. That is, each TA 300-1 to 300-n informs the second device 200 of the portion of the second-device PSK which has been provided by the TA 300-1 to 300-n to the first device 100 for generating the key to encrypt the data.

The method according to one of FIG. 7 or 8 and the method according to FIG. 9 can be considered as respective parts of a method for securely transmitting data from a first device 100 to a second device 200.

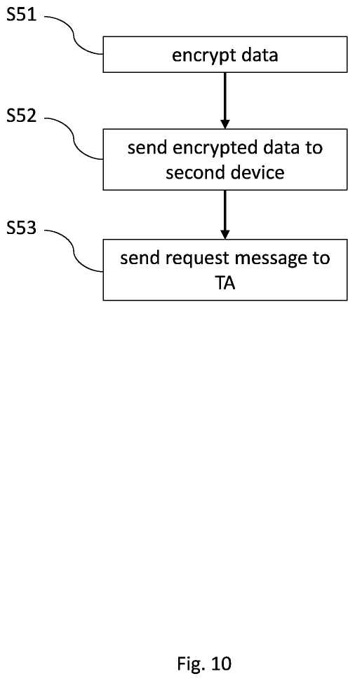

FIG. 10 illustrates a flow diagram illustrating a method for securely transmitting data from a first device 100 to a second device 200. The first device 100 shares a first-device PSK with a TA 300-1 to 300-n.

In step S51, the first device 100 encrypts data, using the first-device PSK. For example, the first device 100 encrypts the data using the first-device PSK K_{A} as an OTP key. The first device 100 may also encrypt the data using any other symmetric encryption method. This first-device PSK is not known a priori to the second device 200.

In step S52, the first device 100 sends the encrypted data to the second device 200.

In step S53, the first device 100 sends a request message to the TA 300, requesting the TA 300-1 to 300-n to send at least a portion of the first-device PSK to the second device 200. The TA 300-1 to 300-n encrypts the first-device PSK using a second-device PSK shared between the TA 300-1 to 300-n and the second device 200.

The first device 100 may identify the first-device PSK K_{A} to be transmitted to the second device 200 by informing the TA 300-1 to 300-n of indices of the key bits of the first-device PSK, or a start index and a length of the first-device PSK.

The first device 100 may encrypt the data using only a portion of the first-device PSK. The first device 100 then transmits to the TA 300-1 to 300-n information characterizing the portion of the first-device PSK that was used to encrypt the data. Sending the request message to the TA 300-1 to 300-n comprises the first device 100 requesting the TA 300-1 to 300-n to send only the used portion of the encrypted first-device PSK to the second device 200.

The invention is not restricted to a particular temporal sequence of method steps S52 and S53. In one embodiment, the first device 100 first sends the encrypted data to the second device 200 and then sends the request message to the TA 300-1 to 300-n. In this embodiment, step S52 is performed before step S53.

In another embodiment, the first device 100 first sends the request message to the TA 300-1 to 300-n and then sends the encrypted data to the second device 200. In this embodiment, step S53 is performed before step S52.

In yet another embodiment, the first device 100 sends the encrypted data to the second device 200 and sends the request message to the TA 300-1 to 300-n at the same time. In this embodiment, steps S52 and S53 are performed simultaneously.

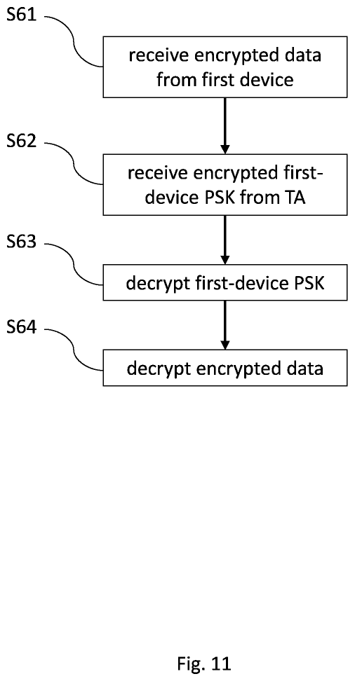

FIG. 11 shows a flow diagram illustrating a method for securely receiving data from a first device 100 by a second device 200. The second device 200 shares with a TA 300-1 to 300-n a second-device PSK.

In step S61, the second device 200 receives encrypted data from the first device 100.

In step S62, the second device 200 receives an encrypted first-device PSK from the TA 300-1 to 300-n. The first-device PSK is shared between the first device 100 and the TA 300-1 to 300-n.

In step S63, the second device 200 decrypts the received encrypted first-device PSK, using the second-device PSK associated with the first-device PSK.

In step S64, the second device 200 decrypts the received encrypted data, using the now decrypted first-device PSK.

The second device 200 may receive information characterizing a portion of the second-device PSK from the TA 300-1 to 300-n. The second device 200 decrypts the received encrypted first-device PSK using only the portion of the second-device PSK.

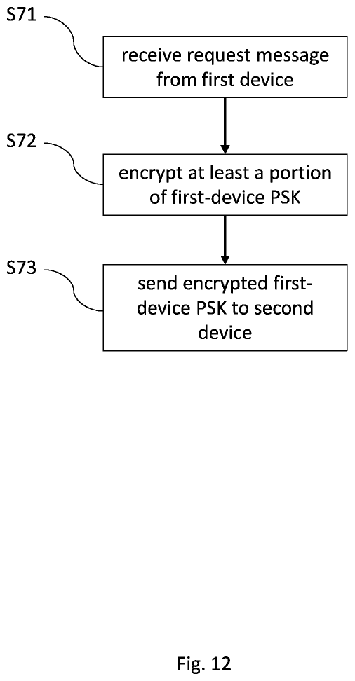

FIG. 12 shows a flow diagram illustrating a method for supporting secure transmittal of data from a first device 100 to a second device 200. The first device 100 shares a first-device PSK with a TA 300-1 to 300-n. The second device 200 shares a second-device PSK with the TA 300-1 to 300-n.

In step S71, the TA 300-1 to 300-n receives a request message from the first device 100, requesting the TA 300-1 to 300-n to send at least a portion of the first-device PSK to the second device 200.

In step S72, the TA 300-1 to 300-n encrypts the at least a portion of the first-device PSK, using at least a portion of the second-device PSK shared between the TA 300-1 to 300-n and the second device 200. The TA 300-1 to 300-n may encrypt the at least a portion of the first-device PSK by encrypting a portion of the first-device PSK which differs from all portions of the first-device PSK which the TA has previously encrypted and sent to the second device. Further, the TA 300-1 to 300-n may encrypt the at least a portion of the first-device PSK by using a portion of the second-device PSK which the TA 300-1 to 300-n has not used for encrypting before, i.e., which differs from all portions of the second-device PSK which the TA has previously used for encrypting.

In an embodiment, the TA 300-1 to 300-n uses the at least a portion of the second-device PSK as an OTP key to encrypt the at least a portion of the first-device PSK. That is, the TA 300-1 to 300-n uses the following formula to generate the encrypted first-device PSK K_{AB}:

$${K}_{AB} = {K}_{A} ⊕ {K}_{B} ,$$

where K_{A} is the (portion of the) first-device PSK and K_{B} is the (portion of the) second-device PSK. The encrypted first-device PSK K_{AB} is therefore obtained by combining the (portion of the) first-device PSK and the (portion of the) second-device PSK by a bitwise XOR operation.

In step S73, the TA 300-1 to 300-n sends the encrypted first-device PSK to the second device 200. This key-encrypted first-device PSK K_{AB} cannot be read by anyone except the second device 200 and the TA 300-1 to 300-n, so the TA 300-1 to 300-n may send K_{AB} to the second device 200 over an unsecured channel. The second device 200 can decrypt the encrypted first-device PSK using the second-device PSK as an OTP, i.e., using the following formula:

$${K}_{A} = {K}_{AB} ⊕ {K}_{B} .$$

As such, the second device 200 may now decrypt the message originally sent by the first device 100 using its knowledge of the first-device PSK K_{A}.

The methods according to FIGS. 10 to 12 can be considered as respective parts of a method for securely transmitting data from a first device to a second device.

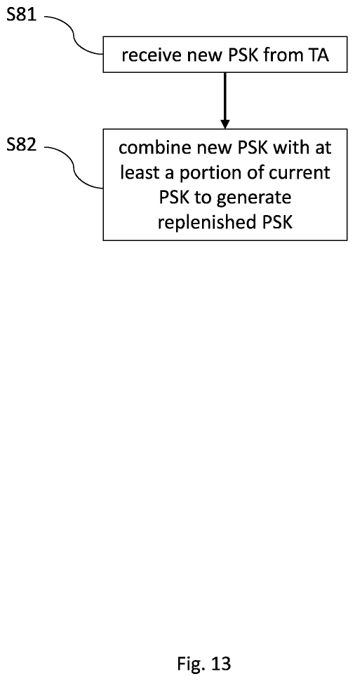

FIG. 13 shows a flow diagram illustrating a method for replenishing a PSK. The PSK is shared between a device and a TA 300-1 to 300-n. The device may be the first device 100 or the second device 200 shown in FIGS. 2 and 3, respectively, and described above.

In step S81, the device receives a new PSK from the TA. In an embodiment, the device receives the new PSK from the TA 300-1 to 300-n via a non-transitory, computer-readable storage medium storing the new PSK. The non-transitory, computer-readable storage medium can be a USB flash drive, a CD ROM, a DVD ROM or the like. The device may receive the new PSK via a direct connection or through a device docking station.

The device may also receive the new PSK from the TA 300-1 to 300-n via a QKD method, using the QKD module of the device and the QKD module 307 of the TA 300-1 to 300-n. The device may receive the new PSK via a direct connection or through a device docking station 400.

In step S82, the device 100 combines the new PSK with at least a portion of a pre-existing PSK to generate a replenished PSK shared between the device 100 and the TA 300-1 to 300-n.

In an embodiment, the device further sends a message to the TA 300-1 to 300-n, allowing the TA 300-1 to 300-n to identify the portion of the pre-shared PSK used to generate the replenished PSK.

The device may further combine the new PSK with at least a portion of the current PSK, using a privacy amplification method.

In an embodiment, the device provides information to the TA 300-1 to 300-n. The information comprises characteristics of the used privacy amplification method and/or a characterization of the used portion of the current PSK.

The device may further reduce a key length of the replenished PSK.

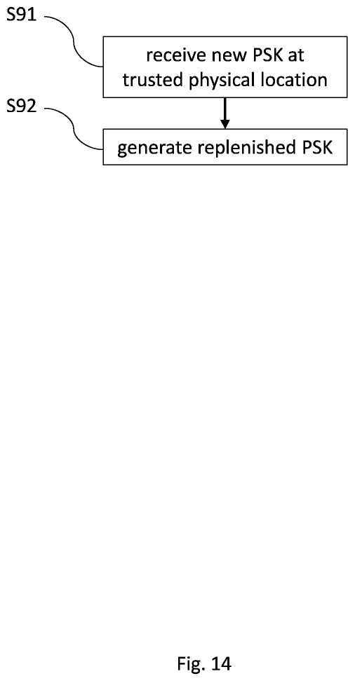

FIG. 14 a flow diagram illustrating a method for replenishing a PSK. The PSK is shared between a device and a TA 300-1 to 300-n. The device may be the first device 100 or the second device 200 shown in FIGS. 2 and 3, respectively, and described above.

In step S91, the device receives a new PSK at a trusted physical location. In some embodiments, until the device receives the new PSK, the new PSK is exclusively known by the TA 300-1 to 300-n. The trusted physical location can be a bank, an automated teller machine, a government building, or a store associated with the TA 300-1 to 300-n. The device may establish a data connection with a station located at the trusted physical location and may receive the new PSK via the station.

Further, the device or a user of the device may go through an authentication procedure at the trusted physical location before the new PSK is provided to the device. The authentication procedure may be based on a password or on biometric data of the user.

In step S92, the device 100 generates a replenished PSK shared between the device and the TA 300-1 to 300-n, using the received new PSK. For example, the new PSK may be the replenished PSK. In another embodiment, the device combines the new PSK with part of the pre-existing PSK to generate the replenished PSK, using a privacy amplification method.

The devices, apparatuses and systems described in the present invention may comprise electronic components and circuits known to those skilled in the art. Therefore, details of the circuitry and its components have not be explained in any greater extent than considered necessary for the understanding and appreciation of the underlying concepts of the present invention.

Where reference is made to a component, such as a device, component, software module or the like, the reference to that component is intended to include as equivalents any component being functionally equivalent, i.e., performing the same function, even though the component is not necessarily structurally equivalent to the component that performs in the exemplary embodiments of the invention.

In the above description, the invention has been described with reference to specific details, e.g., parts of a method, components, materials, and the like. A person skilled in the art will understand that embodiments of the invention may be implemented without one or more of these specific details. For example, although some embodiments have been described with reference to QKD, those of skill in the art will appreciate that said embodiments can be implemented using other quantum networking or quantum communication schemes such as quantum secret sharing and quantum secure direct communication.

All of the US patents, US patent application publications, US patent applications, foreign patents, foreign patent applications, and non-patent publications referred to in this specification, or referred to on any application data sheet, are incorporated by reference in their entireties for all purposes herein.

A person skilled in the art may understand that certain method steps may be described or depicted in a particular order of occurrence while such specificity with respect to sequence is not actually required.

Phrases like “an embodiment” and “another embodiment” are used in the sense that particular features described in connection with the embodiment are included in at least one embodiment. Those phrases do not necessarily all refer to the same embodiment. Terms such as “first”, “second”, “third”, and so on, are used to distinguish between the elements described by these terms. These terms do not necessarily imply any temporal or other prioritization of such elements.

As used herein, the singular forms “a”, “one”, and “the” are also intended to encompass the plural forms unless the context indicates otherwise. In addition, it is understood that the expressions “include” and “including” when used in this specification relates to the presence of features, numbers, steps, operations, elements, and/or components, but does not exclude the presence or addition of one or more features, numbers, steps, operations, elements and/or combinations thereof. As used herein, the term “and/or” includes any and all combinations of one or more of the associated listed elements.

Terms such as “horizontal”, “vertical”, “upper”, “lower”, “above”, “below”, “forward” and “backward” refer to particular orientations of components. The skilled person understands that may therefore depend on the specific orientation and may change if the components are oriented differently.

As used herein, the terms “about,” “approximately,” or “substantially” refer to a value, amount, or property that is close to the specified value, amount, or property. The value, amount, or property is such that a desired function or result is still achieved. According to an example, an amount may differ by less than 10%, 5%, 1%, or 0.1% from the specified amount, respectively.

Even if the invention has been described and illustrated with reference to illustrative embodiments, various modifications may be made without departing from the scope of the present disclosure. Such modifications may comprise replacement of features, components and/or method steps with equivalent features, components and/or method steps; mixing of features, components and/or method steps from different embodiments; and omitting and/or combining features, components and/or method steps from described embodiments. All such modifications and variations are intended to be included herein within the scope of this disclosure and protected by the following claims.

1.-59. (canceled)

60. A method for replenishing a pre-shared key, PSK, wherein the PSK is shared by a device and a trusted authority, TA, wherein the method comprises:
receiving, by the device, a new PSK from the TA; and
combining, by the device, the new PSK with at least a portion of a pre-existing PSK to generate a replenished PSK shared between the device and the TA.

61. The method according to claim 60, wherein the method further comprises:
sending, by the device, a message to the TA, allowing the TA to identify the portion of the pre-existing PSK used to generate the replenished PSK.

62. The method according to claim 60, further comprising:
receiving, by the device, the new PSK via a non-transitory, computer-readable storage medium storing the new PSK.

63. The method according to claim 62, wherein the non-transitory, computer-readable storage medium storing the new PSK is physically protected against opening during shipping.

64. The method according to claim 60, further comprising:
receiving, by the device, the new PSK via a quantum key distribution, QKD, method.

65. The method according to claim 60, further comprising:
receiving, by the device, the new PSK through a device docking station.

66. The method according to claim 65, wherein the device receives the new PSK from the device docking station after the device docking station decodes the new PSK from quantum states received in a QKD method.

67. The method according to claim 66, wherein the device docking station is located at a trusted physical institution.

68. The method according to claim 60, wherein combining the new PSK with at least the portion of the pre-existing PSK comprises combining the new PSK with at least the portion of the pre-existing PSK using a privacy amplification method.

69. The method according to claim 68, further comprising:
providing, by the device, information to the TA, wherein the information comprises characteristics of the privacy amplification method.

70. The method according to claim 60, wherein the replenished PSK is a one-time pad key.

71. The method according to claim 60, further comprising:
reducing, by the device, a key length of the replenished PSK.

72. The method according to claim 71, wherein reducing the key length of the replenished PSK comprises shortening the key by a certain percentage per time span.

73. The method according to claim 60, further comprising:
performing, by the device, an authentication process with the TA to allow the TA to determine that the first device is authorized for PSK replenishment.

74. A device comprising:
an interface; and
a processor,
wherein the processor is configured to:
receive, via the interface, a new pre-shared key, PSK, from a trusted authority, TA; and
combine the new PSK with at least a portion of a pre-existing PSK to generate a replenished PSK shared between the device and the TA.
